(19) United States
(12) Patent Application Publication
(10) Pub. No.: US 2014/0027061 A1
(43) Pub. Date: Jan. 30, 2014

(54) PRESSURE-SENSITIVE ADHESIVE STRENGTH EXHIBITING UNIT, PRESSURE-SENSITIVE ADHESIVE LABEL ISSUING DEVICE, AND PRINTER

(71) Applicant: Seiko Instruments Inc., Chiba-shi (JP)

(72) Inventors: Yoshinori SATO, Chiba-shi (JP); Kazuo TANI, Chiba-shi (JP)

(73) Assignee: Seiko Instruments Inc., Chilba-shi (JP)

(21) Appl. No.: 13/951,042

(22) Filed: Jul. 25, 2013

(30) Foreign Application Priority Data
Jul. 30, 2012 (JP) 2012-168797

(51) Int. Cl. B65C 9/00

(52) U.S. Cl. CPC B65C 9/00
USPC 156/350; 156/499; 156/378; 156/510

(57) ABSTRACT

A pressure-sensitive adhesive strength exhibiting unit including: a thermal head being configured to heat a pressure-sensitive adhesive label, which is conveyed along a conveyance direction, from the pressure-sensitive adhesive layer side to form holes in the non-pressure-sensitive-adhesive function layer; a control part controlling the thermal head; and a discharge mechanism including a first discharge member and a second discharge member, wherein the control part applies the thermal head so as to form the holes and to form a pressure-sensitive adhesive strength non-exhibiting region in which the non-pressure-sensitive-adhesive function layer extends continuously from a downstream end of the label along the conveyance direction, and the second discharge member includes a discharge roller configured to sandwich the label with the first discharge member via the pressure-sensitive adhesive strength non-exhibiting region and to run relatively on the pressure-sensitive adhesive strength non-exhibiting region along with the conveyance of the label.

### RELATED APPLICATIONS

This application claims priority under 35 U.S.C. §119 to Japanese Patent Application No. 2012-168797 filed on Jul. 30, 2012, the entire content of which is hereby incorporated by reference.

### BACKGROUND OF THE INVENTION

1. Field of the Invention

The present invention relates to a pressure-sensitive adhesive strength exhibiting unit for causing a pressure-sensitive adhesive label to exhibit pressure-sensitive adhesive strength, and a pressure-sensitive adhesive label issuing device and a printer including the pressure-sensitive adhesive strength exhibiting unit.

2. Description of the Related Art

Conventionally, as pressure-sensitive adhesive labels used for, for example, a POS label for foods, a logistics/transportation label, a medical label, a baggage tag, and an indication label for bottles and cans, those which are formed of a recording surface (printing surface) formed on a front surface of a base, a pressure-sensitive adhesive layer formed on a rear surface of the base, and release paper (separator) covering the pressure-sensitive adhesive layer have been widely known. Therefore, when the pressure-sensitive adhesive label is used, it is necessary to release the release paper from the pressure-sensitive adhesive layer after printing predetermined information such as a bar code and a price on the recording surface. However, it is actually difficult to recover and recycle the released release paper, and hence, there is a problem that the release paper becomes an industrial waste.

In recent years, a pressure-sensitive adhesive label that does not use release paper has come to be used from the viewpoint of environment protection and alleviation of an environmental burden. For example, a pressure-sensitive adhesive label is known, in which the surface of a recording surface is coated with a release agent such as silicon resin, and a release property between the recording surface and a pressure-sensitive adhesive layer is kept even when the pressure-sensitive adhesive label is rolled into a roll shape. Further, a pressure-sensitive adhesive label is known, which uses, as a pressure-sensitive adhesive layer, a thermally active pressure-sensitive adhesive layer that exhibits pressure-sensitive adhesive strength by heating. Further, a pressure-sensitive adhesive label has been proposed, in which the entire surface of a pressure-sensitive adhesive layer is covered with a non-pressure-sensitive-adhesive resin layer, and the pressure-sensitive adhesive layer is exposed by forming bores (minute openings) in the resin layer by using a heat source such as a heated roll or a thermal head to exhibit pressure-sensitive adhesive strength.

However, the above-mentioned pressure-sensitive adhesive labels using no release paper are subject to a problem that the pressure-sensitive adhesive label cannot be properly conveyed because of the following reason. When the pressure-sensitive adhesive label is conveyed to a discharge port after exhibiting pressure-sensitive adhesive strength, the pressure-sensitive adhesive label may stick to a conveyance roller or the like or dust of the thermally active pressure-sensitive adhesive layer used as the pressure-sensitive adhesive layer may adhere to the conveyance roller or the like.

Aimed at suppressing such a conveyance failure, there is known a configuration of a discharge mechanism in which an annular groove portion is formed in part of a discharge roller for discharging the pressure-sensitive adhesive label having exhibited pressure-sensitive adhesive strength or a plurality of O rings is mounted to the shaft of the discharge roller. The groove portion is formed in the discharge roller at a position corresponding to the vicinity of a lateral end portion of the pressure-sensitive adhesive label, and thereby avoids the discharge roller from contacting with the dust of the thermally active pressure-sensitive adhesive layer, which is likely to remain in the vicinity of the lateral end portion. Further, when the plurality of O rings is mounted to the shaft of the discharge roller, the contact area between the discharge roller and the pressure-sensitive adhesive label is reduced. Such countermeasures are taken to suppress the conveyance failure of the pressure-sensitive adhesive label.

Another known countermeasure to suppress the conveyance failure is a configuration of conveying the pressure-sensitive adhesive label by using an annular elastic belt. According to this configuration, the pressure-sensitive adhesive label is conveyed while the elastic belt frequently expands and contracts, and hence even when the dust of the thermally active pressure-sensitive adhesive layer or the like adheres onto the surface of the elastic belt, the dust can be scraped off by the expansion and contraction action. In this manner, the conveyance failure of the pressure-sensitive adhesive label is suppressed.

In the above-mentioned former configuration, however, the effect of suppressing the conveyance failure is obtained in the initial stage, but the discharge roller cannot be prevented from contacting with the pressure-sensitive adhesive label and hence it is difficult to maintain the effect over time. For example, if even a slight amount of the dust of the thermally active pressure-sensitive adhesive layer or the like adheres onto the discharge roller, another dust is gradually deposited on the dust with time, and a conveyance failure may eventually occur. Also in the above-mentioned latter configuration, the dust adhered onto the elastic belt may grow with time to be too rigid to be scraped off by the expansion and contraction action of the elastic belt. Thus, although the effect of suppressing the conveyance failure is obtained in the initial stage, a conveyance failure may eventually occur.

Note that, as a method of conveying the pressure-sensitive adhesive label while preventing the contact with the pressure-sensitive adhesive layer, it is conceivable to convey the pressure-sensitive adhesive label while absorbing and holding the pressure-sensitive adhesive label by using, for example, suction force of a vacuum or the like or electrostatic force. In this case, however, there is another problem that the configuration is apt to be complicated and upsized and is heavy and expensive.

### SUMMARY OF THE INVENTION

Therefore, in this technical field, demands have been made for a pressure-sensitive adhesive strength exhibiting unit that is capable of stably conveying and discharging a pressure-sensitive adhesive label without any conveyance failure over the lapse of time after causing the pressure-sensitive adhesive label to exhibit pressure-sensitive adhesive strength and capable of simplifying the configuration, and a pressure-sensitive adhesive label issuing device and a printer that include the pressure-sensitive adhesive strength exhibiting unit.

A pressure-sensitive adhesive strength exhibiting unit according to one embodiment of the present invention is configured to heat a pressure-sensitive adhesive label to exhibit pressure-sensitive adhesive strength thereof, the pressure-sensitive adhesive label including a printable layer and a pressure-sensitive adhesive layer, the printable layer being provided on one surface of a base, the pressure-sensitive adhesive layer being provided on another surface of the base and covered by a non-pressure-sensitive-adhesive function layer, the pressure-sensitive adhesive strength exhibiting unit including: a thermal head including a plurality of heat generating elements arranged along a width direction of the pressure-sensitive adhesive label, the thermal head being configured to heat the pressure-sensitive adhesive label, which is conveyed along a conveyance direction, from the pressure-sensitive adhesive layer side to form holes in the non-pressure-sensitive-adhesive function layer by the plurality of heat generating elements, to thereby expose the pressure-sensitive adhesive layer; a control part for applying heat energy independently to the plurality of heat generating elements to control heat generation of the plurality of heat generating elements; and a discharge mechanism placed on a downstream side of the thermal head in the conveyance direction, the discharge mechanism including a first discharge member placed on the printable layer side and a second discharge member placed on the non-pressure-sensitive-adhesive function layer side, the discharge mechanism being configured to convey the pressure-sensitive adhesive label to a discharge position located on the downstream side of the discharge mechanism while sandwiching the pressure-sensitive adhesive label between the first discharge member and the second discharge member. The control part applies the heat energy to the plurality of heat generating elements so as to form the holes and to form a pressure-sensitive adhesive strength non-exhibiting region in which the non-pressure-sensitive-adhesive function layer extends continuously from a downstream end of the pressure-sensitive adhesive label along the conveyance direction. The second discharge member includes a discharge roller configured to sandwich the pressure-sensitive adhesive label with the first discharge member via the pressure-sensitive adhesive strength non-exhibiting region and to run relatively on the pressure-sensitive adhesive strength non-exhibiting region along with the conveyance of the pressure-sensitive adhesive label.

According to the pressure-sensitive adhesive strength exhibiting unit of one embodiment of the present invention, the control part applies the heat energy independently to the plurality of heat generating elements of the thermal head and thereby causes the heat generating elements to generate heat. In this manner, the function layer of the pressure-sensitive adhesive label can be locally heated only in regions in contact with the heated heat generating elements, and the holes (minute openings) can be formed in the regions. When the holes are formed, the pressure-sensitive adhesive layer is exposed through the holes, and hence the pressure-sensitive adhesive strength can be exhibited. Then, the application of heat energy to the plurality of heat generating elements is repeated along with the conveyance of the pressure-sensitive adhesive label. In this manner, the pressure-sensitive adhesive strength can be exhibited in a desired region of the pressure-sensitive adhesive label.

By the way, in order to exhibit the pressure-sensitive adhesive strength, the control part controls not to apply heat energy to a specific heat generating element so that the function layer may be continuously left from the downstream end of the pressure-sensitive adhesive label along the conveyance direction. In this manner, the pressure-sensitive adhesive strength non-exhibiting region that extends along the conveyance direction can be formed at the same time when the pressure-sensitive adhesive strength is exhibited. Then, after the pressure-sensitive adhesive strength is exhibited, the discharge mechanism conveys the pressure-sensitive adhesive label to the discharge position while sandwiching the pressure-sensitive adhesive label between the first discharge member and the second discharge member. At this time, the discharge roller of the second discharge member sandwiches the pressure-sensitive adhesive label with the first discharge member via the pressure-sensitive adhesive strength non-exhibiting region. In this manner, the discharge roller is prevented from contacting with the pressure-sensitive adhesive layer. In addition, the discharge roller runs relatively on the pressure-sensitive adhesive strength non-exhibiting region along with the conveyance of the pressure-sensitive adhesive label, and hence the pressure-sensitive adhesive label can be stably conveyed to the discharge position and discharged while being prevented from adhering to the discharge roller.

In particular, unlike the conventional one, the contact itself between the pressure-sensitive adhesive layer and the discharge roller can be prevented, and hence, after the pressure-sensitive adhesive strength is exhibited, the pressure-sensitive adhesive label can be stably conveyed without causing any conveyance failure over the lapse of time and can be reliably discharged. Consequently, a high-quality pressure-sensitive adhesive label can be obtained. Further, no special configuration or the like needs to be employed, and hence the configuration can be simplified without increasing the size and cost.

In the pressure-sensitive adhesive strength exhibiting unit according to one embodiment of the present invention, it is preferred that the control part be configured to apply the heat energy to the plurality of heat generating elements so that a plurality of the pressure-sensitive adhesive strength non-exhibiting regions is formed with intervals in the width direction of the pressure-sensitive adhesive label, and that the discharge roller be provided in number corresponding to a number of the plurality of the pressure-sensitive adhesive strength non-exhibiting regions to be formed.

In this case, a plurality of discharge rollers is used, and hence the pressure-sensitive adhesive label can be more stably conveyed. Further, it is possible to handle a plurality of kinds of pressure-sensitive adhesive labels having different lateral sizes.

In the pressure-sensitive adhesive strength exhibiting unit according to one embodiment of the present invention, it is preferred that the control part be configured to apply the heat energy to the plurality of heat generating elements so that the pressure-sensitive adhesive strength non-exhibiting region is formed on the inner side away from lateral both end portions of the pressure-sensitive adhesive label by a predetermined distance or more.

In this case, it is possible to prevent the peeling of label edges (lateral both end portions) when the pressure-sensitive adhesive label is stuck onto a target. Consequently, the quality of the pressure-sensitive adhesive label can be enhanced.

In the pressure-sensitive adhesive strength exhibiting unit according to one embodiment of the present invention, it is preferred that the discharge roller include: a disc-like roller main body; and an annular elastic ring that is mounted on an outer peripheral surface of the disc-like roller main body and is larger in diameter than the disc-like roller main body.

In this case, only a region of the elastic ring such as an O ring can be brought into contact with the pressure-sensitive adhesive strength non-exhibiting region, and hence the formation width of the pressure-sensitive adhesive strength non-exhibiting region can be reduced correspondingly to the thickness of the elastic ring. Therefore, a region for exhibiting the pressure-sensitive adhesive strength can be easily ensured accordingly, and the pressure-sensitive adhesive strength can be more easily enhanced. On the other hand, the thickness of the roller main body can be increased, and hence the rigidity can be easily ensured and the reliability of the discharge roller can be easily enhanced. Further, the elastic ring and the pressure-sensitive adhesive strength non-exhibiting region can be brought into contact with each other at an appropriate contact resistance by utilizing the elastic property of the elastic ring, and hence a stable conveyance of the pressure-sensitive adhesive label can be easily performed without causing a slippage or the like.

In the pressure-sensitive adhesive strength exhibiting unit according to one embodiment of the present invention, it is preferred that an outer peripheral surface of the discharge roller be an uneven surface on which irregularities are repeated in a circumferential direction over an entire circumference thereof.

In this case, the outer peripheral surface of the discharge roller is the uneven surface, and hence the discharge roller can be brought into contact with the pressure-sensitive adhesive label in a state of biting into the pressure-sensitive adhesive strength non-exhibiting region. Consequently, a stable conveyance of the pressure-sensitive adhesive label can be easily performed without causing a slippage or the like.

In the pressure-sensitive adhesive strength exhibiting unit according to one embodiment of the present invention, it is preferred that the pressure-sensitive adhesive strength exhibiting unit further include a coupling member for coupling the thermal head and the second discharge member to each other in a state in which the second discharge member is positioned relative to the thermal head along the width direction of the pressure-sensitive adhesive label.

In this case, the second discharge member is positioned relative to the thermal head along the width direction of the pressure-sensitive adhesive label by the coupling member, and hence an accurate alignment between the position of the pressure-sensitive adhesive strength non-exhibiting region formed by the thermal head and the position of the discharge roller of the second discharge member can be easily performed in the width direction of the pressure-sensitive adhesive label. Consequently, the pressure-sensitive adhesive label can be conveyed while being more reliably prevented from adhering to the discharge roller.

In the pressure-sensitive adhesive strength exhibiting unit according to one embodiment of the present invention, it is preferred that the pressure-sensitive adhesive strength exhibiting unit further include: a read sensor for reading a surface state of the pressure-sensitive adhesive label; and a display unit including a plurality of LEDs arranged along the width direction of the pressure-sensitive adhesive label, the read sensor and the display unit being placed between the thermal head and the second discharge member, that the control part be configured to switch between a pressure-sensitive adhesive strength exhibiting mode for causing the pressure-sensitive adhesive label to exhibit pressure-sensitive adhesive strength and a position adjustment mode for adjusting a position of the discharge roller, that the control part be configured to apply, when entering the position adjustment mode, heat energy to a heat generating element that has not been applied with heat energy in order to form the pressure-sensitive adhesive strength non-exhibiting region among the plurality of heat generating elements, that the read sensor be configured to read the surface state of the pressure-sensitive adhesive label when entering the position adjustment mode, and to identify a position of the heat generating element applied with the heat energy based on a change in the read surface state and output the identified position to the control part, and that the control part be configured to operate the display unit so that, among the plurality of LEDs, an LED that is placed at the same position in the width direction of the pressure-sensitive adhesive label as the position of the heat generating element identified by the read sensor is turned on.

In this case, an accurate alignment between the pressure-sensitive adhesive strength non-exhibiting region and the discharge roller can be easily performed, for example, in the case where the size of the pressure-sensitive adhesive label has been changed or the thermal head has been replaced with another one. Specifically, when the mode is switched to the position adjustment mode, the control part applies heat energy to a heat generating element that has not been applied with heat energy in the pressure-sensitive adhesive strength exhibiting mode (a specific heat generating element that has not been applied with heat energy in order to form the pressure-sensitive adhesive strength non-exhibiting region). Then, the read sensor placed on the downstream side of the thermal head in the conveyance direction identifies the position of the heat generating element that has been applied with heat energy at that time based on the change in the surface state of the pressure-sensitive adhesive label, and outputs the identified position to the control part.

Then, the control part operates the display unit so that, among the plurality of LEDs, an LED that is placed at the same position in the width direction of the pressure-sensitive adhesive label as the position of the heat generating element identified by the read sensor may be turned on. In this manner, by checking the position of the turned-on LED, the formation position of the pressure-sensitive adhesive strength non-exhibiting region can be accurately grasped. Consequently, by aligning the position of the discharge roller with the position of the turned-on LED, the pressure-sensitive adhesive strength non-exhibiting region and the discharge roller can be aligned with each other with high accuracy.

In the pressure-sensitive adhesive strength exhibiting unit according to one embodiment of the present invention, it is preferred that the pressure-sensitive adhesive strength exhibiting unit further include a detection part for detecting sagging of the pressure-sensitive adhesive label, the detection part being placed on the downstream side of the discharge mechanism in the conveyance direction.

In this case, it is easily determined whether or not the pressure-sensitive adhesive strength non-exhibiting region and the discharge roller are properly aligned with each other. For example, in the case where the pressure-sensitive adhesive strength non-exhibiting region and the discharge roller are aligned with each other, the pressure-sensitive adhesive label, which is conveyed toward the discharge position by the discharge mechanism, is conveyed to the downstream side without sagging. On the other hand, in the case where the pressure-sensitive adhesive strength non-exhibiting region and the discharge roller are misaligned with each other in the width direction of the pressure-sensitive adhesive label, the pressure-sensitive adhesive layer sticks to the discharge roller, with the result that the pressure-sensitive adhesive label is rolled around the discharge roller and sags. Then, the detection part detects the sagging of the pressure-sensitive adhesive label. Consequently, it can be easily determined whether or not the pressure-sensitive adhesive strength non-exhibiting region and the discharge roller are properly aligned with each other based on the presence/absence of the detection by the detection part, and the position of the discharge roller can easily adjusted based on the presence/absence of the detection.

In the pressure-sensitive adhesive strength exhibiting unit according to one embodiment of the present invention, it is preferred that the control part be configured to switch between a pressure-sensitive adhesive strength exhibiting mode for exhibiting pressure-sensitive adhesive strength and a position adjustment mode for adjusting the position of the discharge roller, and that the control part be configured to apply, when entering the position adjustment mode, heat energy to the plurality of heat generating elements so that the pressure-sensitive adhesive strength non-exhibiting region is formed in a state in which a lateral width of the pressure-sensitive adhesive strength non-exhibiting region is reduced in a stepwise manner from the downstream end of the pressure-sensitive adhesive label.

In this case, when the mode is switched to the position adjustment mode, the control part applies heat energy to the heat generating elements so as to form not a pressure-sensitive adhesive strength non-exhibiting region having a constant width but the stepwise pressure-sensitive adhesive strength non-exhibiting region whose lateral width is reduced in a stepwise manner from the downstream end of the pressure-sensitive adhesive label. Consequently, how much the position of the discharge roller deviates can be grasped based on the lateral width of the pressure-sensitive adhesive strength non-exhibiting region at the time of the detection by the detection part, and hence the position adjustment can be easily performed.

In the pressure-sensitive adhesive strength exhibiting unit according to one embodiment of the present invention, it is preferred that the control part be configured to apply heat energy to the plurality of heat generating elements so that the lateral width of the pressure-sensitive adhesive strength non-exhibiting region is changed in a stepwise manner in association with a length from the downstream end of the pressure-sensitive adhesive label along the conveyance direction, and to calculate, when the detection part detects the sagging, the lateral width of the pressure-sensitive adhesive strength non-exhibiting region at a time of the detection based on a length of the pressure-sensitive adhesive label from the downstream end of the pressure-sensitive adhesive label to a detected position.

In this case, when the detection part detects the sagging, the lateral width of the pressure-sensitive adhesive strength non-exhibiting region at the time of the detection can be calculated based on the length of the pressure-sensitive adhesive label from the downstream end of the pressure-sensitive adhesive label to the detected position, and hence how much the position of the discharge roller deviates can be quickly grasped.

A pressure-sensitive adhesive label issuing device according to one embodiment of the present invention includes: the pressure-sensitive adhesive strength exhibiting unit according to one embodiment of the present invention; and a cutter unit for cutting the pressure-sensitive adhesive label to a desired length.

According to the pressure-sensitive adhesive label issuing device of one embodiment of the present invention, the pressure-sensitive adhesive label can be cut to a desired length by the cutter unit, and hence a high-quality pressure-sensitive adhesive label can be issued.

A printer according to one embodiment of the present invention includes: the pressure-sensitive adhesive label issuing device according to one embodiment of the present invention; and a printing unit for printing on the printable layer, the printing unit being placed on an upstream side of the pressure-sensitive adhesive strength exhibiting unit in the conveyance direction.

According to the printer of one embodiment of the present invention, desired information can be stably printed on the printable layer before the pressure-sensitive adhesive label is caused to exhibit pressure-sensitive adhesive strength by the pressure-sensitive adhesive strength exhibiting unit, and hence clear printing can be performed. Then, the pressure-sensitive adhesive label having exhibited pressure-sensitive adhesive strength can be reliably discharged without causing any conveyance failure, and hence a high-quality pressure-sensitive adhesive label can be obtained.

As described above, according to each of the embodiments of the present invention, after the pressure-sensitive adhesive label is caused to exhibit pressure-sensitive adhesive strength, the pressure-sensitive adhesive label can be stably conveyed and discharged without causing any conveyance failure over the lapse of time, and further the configuration can be simplified.

### BRIEF DESCRIPTION OF THE DRAWINGS

In the accompanying drawings:

FIG. 1 is a structural diagram of a printer including a pressure-sensitive adhesive strength exhibiting unit and a pressure-sensitive adhesive label issuing device, illustrating an embodiment according to the present invention;

FIG. 2 is an enlarged cross-sectional view of a pressure-sensitive adhesive label illustrated in FIG. 1;

FIG. 3 is a plan view of a thermal head of the pressure-sensitive adhesive strength exhibiting unit illustrated in FIG. 1;

FIG. 4 is a cross-sectional view taken along line A-A of the thermal head illustrated in FIG. 3;

FIG. 5 is an enlarged plan view of electrode parts and heat generating elements of the thermal head illustrated in FIG. 3;

FIG. 6 is a plan view of the pressure-sensitive adhesive label that has exhibited pressure-sensitive adhesive strength by the pressure-sensitive adhesive strength exhibiting unit in a state in which a pressure-sensitive adhesive strength non-exhibiting region is formed;

FIG. 7 is a perspective view of a discharge mechanism of the pressure-sensitive adhesive strength exhibiting unit;

FIG. 8 is a plan view illustrating a relationship between a second discharge member of the discharge mechanism and the pressure-sensitive adhesive strength non-exhibiting region formed in the pressure-sensitive adhesive label;

FIG. 9 is a perspective view illustrating a modified example of the discharge mechanism;

FIG. 10A is a side view illustrating a modified example of a second discharge roller of the discharge mechanism, and FIG. 10B is a cross-sectional view taken along the line B-B of FIG. 10A;

FIG. 11 is a diagram illustrating a modified example of the embodiment of the present invention, and is a plan view of a coupling member for coupling the thermal head and the second discharge member to each other;

FIG. 12 is a diagram illustrating another modified example of the embodiment of the present invention, and is a side view illustrating a state in which a read sensor and a display unit are placed between the thermal head and the second discharge member;

FIG. 13 is a plan view illustrating the state of FIG. 12 as viewed from above;

FIG. 14 is a diagram illustrating a state in which an LED of the display unit is turned on in the state of FIG. 13;

FIG. 15 is a diagram illustrating another modified example of the embodiment of the present invention, and is a plan view illustrating a state in which a detection part and a second discharge mechanism are placed on the downstream side of the discharge mechanism;

FIG. 16 is a side view illustrating the state of FIG. 15 as viewed from side;

FIG. 17 is a plan view of the pressure-sensitive adhesive label, illustrating a modified example of the pressure-sensitive adhesive strength non-exhibiting region;

FIG. 18 is a diagram illustrating a state in which the second discharge roller is located on the center line of the pressure-sensitive adhesive strength non-exhibiting region illustrated in FIG. 17; and

FIG. 19 is a diagram illustrating a state in which the second discharge roller is located away from the center line of the pressure-sensitive adhesive strength non-exhibiting region illustrated in FIG. 17.

### DETAILED DESCRIPTION OF THE PREFERRED EMBODIMENTS

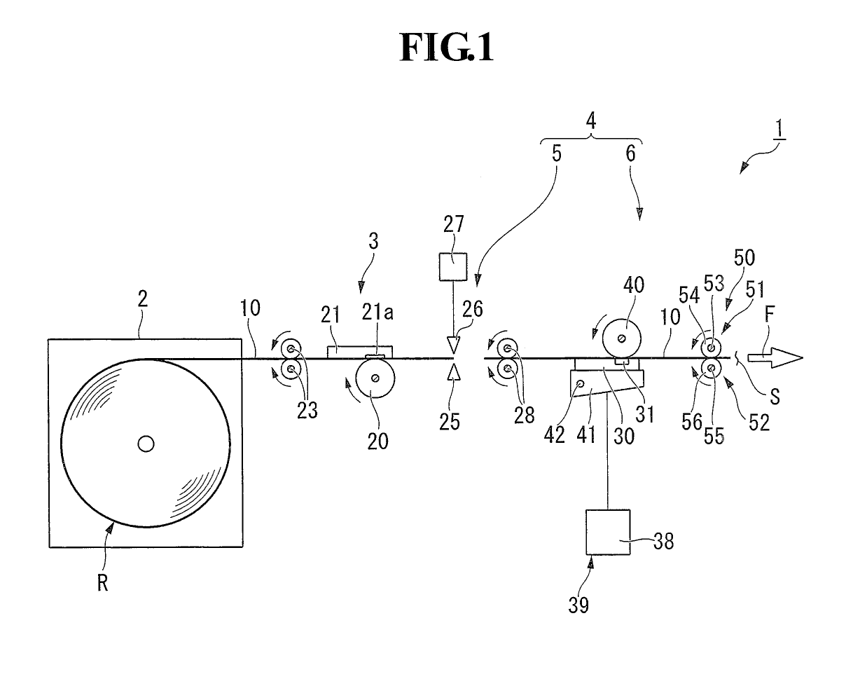

Referring to the drawings, an embodiment of the present invention is described below. As illustrated in FIG. 1, a printer (thermal printer) 1 in this embodiment is a device that is configured to use roll paper R having a belt-shaped pressure-sensitive adhesive label 10 rolled therearound into a roll, print on the pressure-sensitive adhesive label 10 unrolled from the roll paper R and thereafter cut the pressure-sensitive adhesive label 10 to a predetermined length, and issue a label in a state in which the pressure-sensitive adhesive label 10 exhibits pressure-sensitive adhesive strength. Note that, in this embodiment, in the state illustrated in FIG. 1, the conveyance direction of the pressure-sensitive adhesive label 10 is indicated by the arrow F, and the roll paper R side is referred to as “upstream side in conveyance direction” (hereinafter referred to simply as “upstream side”) while the opposite direction is referred to as “downstream side in conveyance direction” (hereinafter referred to simply as “downstream side”).

### (Pressure-Sensitive Adhesive Label)

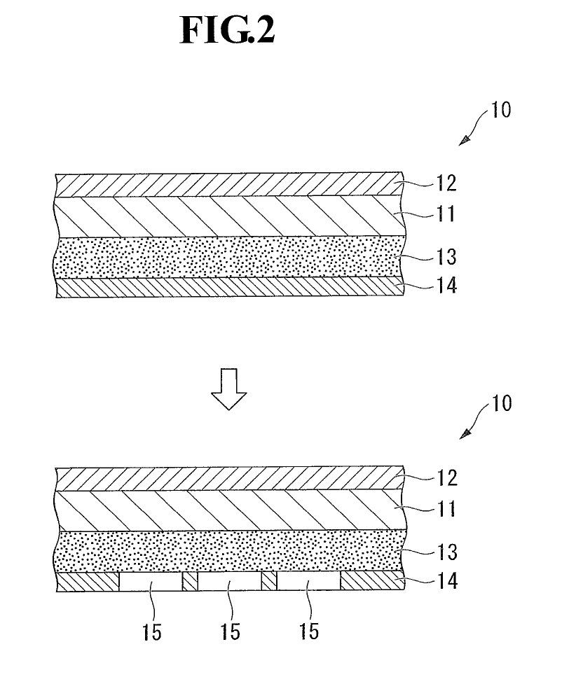

First, the roll paper R having the belt-shaped pressure-sensitive adhesive label 10 rolled therearound is received and held rotatably in a roll paper receiving portion 2 placed on the upstream side of the printer 1. As illustrated in FIG. 2, the pressure-sensitive adhesive label 10 includes a base 11, a printable layer 12 laminated on one surface of the base 11, a pressure-sensitive adhesive layer 13 laminated on another surface of the base 11, and a non-pressure-sensitive-adhesive function layer 14 that covers the pressure-sensitive adhesive layer 13 to regulate its adhesion. Note that, in this embodiment, the printable layer 12 side of the pressure-sensitive adhesive label 10 is referred to as “front surface (one surface) side”, and the function layer 14 side thereof is referred to as “rear surface (another surface) side”.

The printable layer 12 is a thermosensitive recording layer that develops color by heating and formed over an entire surface of front surface of the base 11. The pressure-sensitive adhesive layer 13 is formed of, for example, a pressure-sensitive adhesive that exhibits pressure-sensitive adhesiveness merely by being applied with a slight pressure at room temperature for a short period of time without using water, a solvent, or heat, and formed over an entire surface of the rear surface of the base 11.

It is preferred that the pressure-sensitive adhesive have both cohesion and an elastic force, and high pressure-sensitive adhesiveness, and be easily released. Note that, the pressure-sensitive adhesive layer 13 is not limited to the one that is formed of a pressure-sensitive adhesive and may be, for example, the one that is formed of a rubber-based pressure-sensitive adhesive such as natural rubber, styrene butadiene rubber (SBR), or polyisobutylene rubber; a non-crosslinking acrylic pressure-sensitive adhesive obtained by copolymerizing a monomer having a low glass transition point with a monomer having a high glass transition point; or a silicon-based pressure-sensitive adhesive made of silicon having high cohesion and silicon resin having high pressure-sensitive adhesive strength.

The function layer 14 covers the entire surface of the pressure-sensitive adhesive layer 13 and is formed of a thermosensitive film or the like in which bores (holes) 15 are formed by heating. The bores 15 are formed by being heated locally by heat generating elements 31 of a thermal head 30 of the pressure-sensitive adhesive strength exhibiting unit 6 described later. When the bores 15 are formed, the pressure-sensitive adhesive layer 13 is exposed outside through the bores 15, and hence pressure-sensitive adhesive strength is exhibited.

### (Printer)

Subsequently, a description is given of the printer 1. As illustrated in FIG. 1, the printer 1 includes the roll paper receiving portion 2, a printing unit 3 for printing on the printable layer 12 of the belt-shaped pressure-sensitive adhesive label 10 unrolled from the roll paper R, and a pressure-sensitive adhesive label issuing device 4 for cutting the pressure-sensitive adhesive label 10 printed by the printing unit 3 to a desired length and heating the pressure-sensitive adhesive label 10 to exhibit pressure-sensitive adhesive strength.

### (Printing Unit)

The printing unit 3 includes a printing platen roller 20 and a printing thermal head 21, which are arranged to be opposed across the pressure-sensitive adhesive label 10. The printing unit 3 is placed between the roll paper receiving portion 2 and the pressure-sensitive adhesive label issuing device 4. The printing thermal head 21 is a line thermal head in which a large number of heat generating elements 21a are arranged along the width direction of the pressure-sensitive adhesive label 10. The printing thermal head 21 is placed on the front surface side of the pressure-sensitive adhesive label 10. The printing thermal head 21 is biased toward the pressure-sensitive adhesive label 10 by an elastic member (not shown) such as a coil spring, and is brought into pressure contact with an outer peripheral surface of the printing platen roller 20 while sandwiching the pressure-sensitive adhesive label 10. The printing platen roller 20 is placed on the rear surface side of the pressure-sensitive adhesive label 10, and is rotated by rotational force transmitted from a drive source (not shown).

In the printing unit 3, when the printing platen roller 20 is rotated by the driving of the drive source in the state in which the pressure-sensitive adhesive label 10 is sandwiched between the printing thermal head 21 and the printing platen roller 20, the pressure-sensitive adhesive label 10 can be unrolled from the roll paper R to be conveyed to the downstream side. Note that, between the printing unit 3 and the roll paper receiving portion 2, there are placed first conveyance rollers 23 for conveying the pressure-sensitive adhesive label 10 toward the downstream side while sandwiching the pressure-sensitive adhesive label 10 in the thickness direction.

### (Pressure-Sensitive Adhesive Label Issuing Device)

The pressure-sensitive adhesive label issuing device 4 includes a cutter unit 5 and a pressure-sensitive adhesive strength exhibiting unit 6. The cutter unit 5 cuts the pressure-sensitive adhesive label 10 printed by the printing unit 3 to a desired length. The pressure-sensitive adhesive strength exhibiting unit 6 heats the pressure-sensitive adhesive label 10 cut by the cutter unit 5 so that the pressure-sensitive adhesive label 10 may exhibit pressure-sensitive adhesive strength. Note that, in this embodiment, a description is given of the case where the cutter unit 5 is placed on the upstream side of the pressure-sensitive adhesive strength exhibiting unit 6.

### (Cutter Unit)

The cutter unit 5 includes a fixed blade 25 and a movable blade 26, and is placed on the downstream side of the printing unit 3. The fixed blade 25 and the movable blade 26 are placed so that the blades may oppose to each other across the pressure-sensitive adhesive label 10 in the thickness direction. Here, the fixed blade 25 is placed on the rear surface side of the pressure-sensitive adhesive label 10, and the movable blade 26 is placed on the front surface side of the pressure-sensitive adhesive label 10. Note that, the fixed blade 25 may be placed on the front surface side of the pressure-sensitive adhesive label 10, and the movable blade 26 may be placed on the rear surface side of the pressure-sensitive adhesive label 10.

The movable blade 26 can slide to approach or be separate with respect to the fixed blade 25 by a cutter drive portion 27 and can cut the pressure-sensitive adhesive label 10 while sandwiching the pressure-sensitive adhesive label 10 between the movable blade 26 and the fixed blade 25 in the vertical direction. Note that, on the downstream side of the cutter unit 5, there are placed second conveyance rollers 28 for conveying the pressure-sensitive adhesive label 10 to the further downstream side while sandwiching the pressure-sensitive adhesive label 10 in the thickness direction.

### (Pressure-Sensitive Adhesive Strength Exhibiting Unit)

The pressure-sensitive adhesive strength exhibiting unit 6 includes a thermal head 30 for exhibiting pressure-sensitive adhesive strength, a platen roller 40 for exhibiting pressure-sensitive adhesive strength, and a discharge mechanism 50. The thermal head 30 heats the pressure-sensitive adhesive label 10 to form a bore 15 in the function layer 14, to thereby exhibit the pressure-sensitive adhesive strength. The platen roller 40 conveys the pressure-sensitive adhesive label 10 to the downstream side while sandwiching the pressure-sensitive adhesive label 10 with the thermal head 30. The discharge mechanism 50 is placed on the downstream side of the thermal head 30 and the platen roller 40, and conveys the pressure-sensitive adhesive label 10 having exhibited pressure-sensitive adhesive strength to a discharge position S located on the further downstream side while sandwiching the pressure-sensitive adhesive label 10 in the thickness direction.

The thermal head 30 is a line thermal head that includes a plurality of heat generating elements 31 arranged in line along the width direction of the pressure-sensitive adhesive label 10 and is capable of forming the bores 15 in the function layer 14 of the pressure-sensitive adhesive label 10 by heating the function layer 14 independently by the heat generating elements 31. The thermal head 30 is placed on the rear surface side of the pressure-sensitive adhesive label 10.

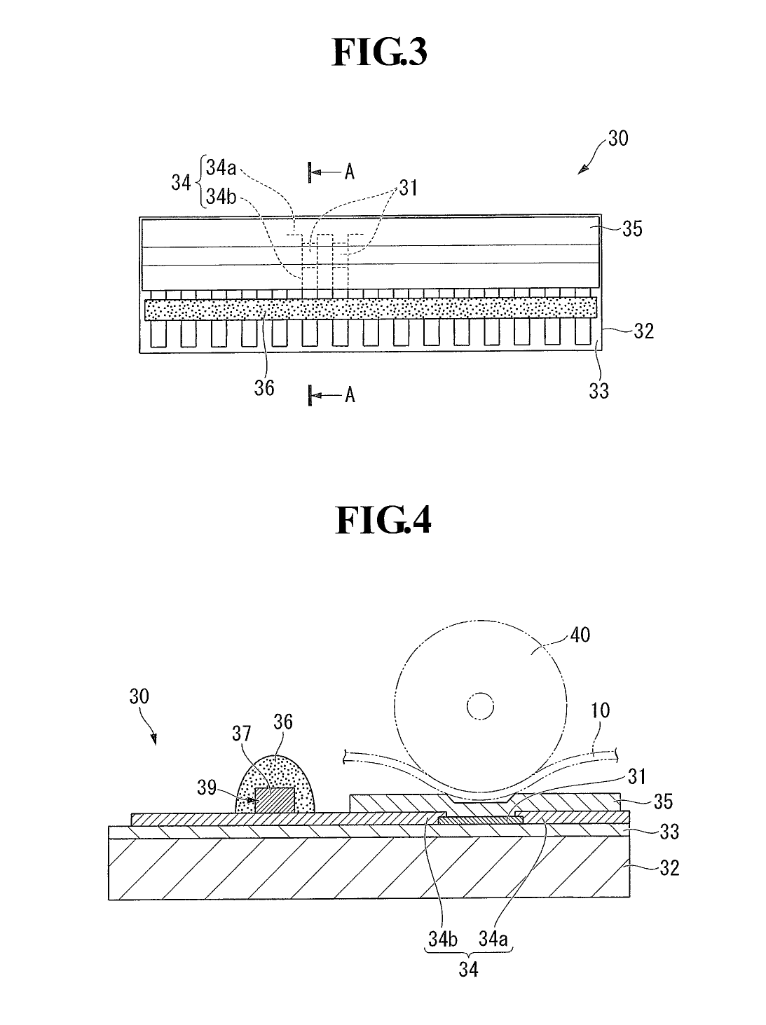

Specifically, as illustrated in FIGS. 3 and 4, the thermal head 30 includes a ceramic substrate 32 that is a heat-radiating substrate, a glaze layer (heat storage layer) 33 laminated over the entire surface of the ceramic substrate 32, heat generating elements 31 and an electrode part 34 laminated on the glaze layer 33, and a protective layer 35 for protecting the heat generating elements 31 and a part of the electrode part 34.

The ceramic substrate 32 is supported by a head support member 41 (see FIG. 1). The head support member 41 is supported by a shaft 42 extending in the width direction of the pressure-sensitive adhesive label 10, and is pivotable about the shaft 42. Further, the head support member 41 is biased to the platen roller 40 side by a coil spring or the like (not shown). Therefore, the thermal head 30 comes into pressure contact with an outer circumferential surface of the platen roller 40. Thus, the pressure-sensitive adhesive label 10 is sandwiched between the thermal head 30 and the platen roller 40 and is pressed against the thermal head 30 (see FIG. 1).

The glaze layer 33 is formed, for example, when a printed glass paste is baked at a predetermined temperature (e.g., 1,300° C. to 1,500° C.). The heat generating elements 31 are formed by laminating a heat generating resistive member made of, for example, Ta—SiO₂ on the glaze layer 33 by sputtering or the like, and then by patterning the heat generating resistive member by photolithography or the like. At this time, as illustrated in FIG. 5, the heat generating elements 31 are aligned at an equal interval with a predetermined pitch P in line in a longitudinal direction of the ceramic substrate 32.

As illustrated in FIGS. 3 to 5, the electrode part 34 is formed by laminating, for example, a layer of Al, Cu, or Au on the glaze layer 33 by sputtering or the like and then by patterning the layer of Al, Cu, or Au by photolithography or the like. The electrode part 34 includes a common electrode part 34a that is electrically connected to all the plurality of heat generating elements 31, and individual electrode parts 34b that are electrically connected to the respective heat generating elements 31. Thus, heat energy can be applied to each of the plurality of heat generating elements 31 through the electrode part 34 to cause each heat generating element 31 to generate heat independently.

An IC part 37 protected by a sealing part 36 made of resin or the like is mounted on each individual electrode part 34b. The IC parts 37 cooperate with a CPU 38 illustrated in FIG. 1 to control the heat generation of the heat generating elements 31. Thus, the IC parts 37 and the CPU 38 function as a control part 39 for controlling the heat generation by applying heat energy to each of the plurality of heat generating elements 31 independently through the electrode part 34. Note that, the control part 39 controls the actuation of each of other components comprehensively.

The protective layer 35 prevents oxidation and abrasion of the electrode part 34 and the heat generating elements 31, and is formed of, for example, a hard metal oxide such as Si—O—N or Si—Al—O—N. Then, the protective layer 35 completely covers and protects the plurality of heat generating elements 31 and the common electrode part 34a, and covers and protects a part of the individual electrode parts 34b.

As illustrated in FIG. 1, the platen roller 40 is a rubber roller rotated by a drive motor (not shown) whose drive is controlled by the control part 39, is provided on the upper surface side of the pressure-sensitive adhesive label 10 and conveys the pressure-sensitive adhesive label 10 to the under stream side while sandwiching the pressure-sensitive adhesive label 10 between the thermal head 30 and the platen roller 40.

By the way, the control part 39 formed of the CPU 38 and the IC part 37 repeats the application of heat energy to the plurality of heat generating elements 31 along with the driving of the platen roller 40 to form the plurality of bores 15 in the function layer 14 of the pressure-sensitive adhesive label 10. In this manner, the control part 39 can cause the pressure-sensitive adhesive label 10 to exhibit the pressure-sensitive adhesive strength in a desired range thereof.

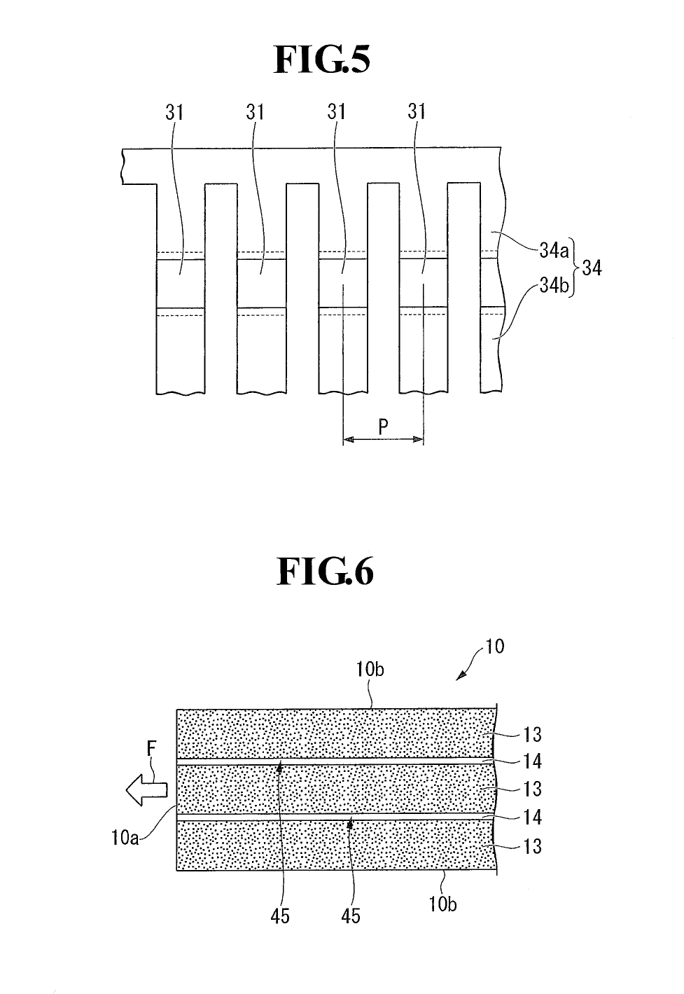

In particular, in order to exhibit the pressure-sensitive adhesive strength, the control part 39 controls the application of heat energy to the heat generating elements 31 so as to form a pressure-sensitive adhesive strength non-exhibiting region 45 in which the function layer 14 continuously extends from a downstream end 10a of the pressure-sensitive adhesive label 10 along the conveyance direction as illustrated in FIG. 6. In addition, in this embodiment, the control part 39 controls the application of heat energy so that two pressure-sensitive adhesive strength non-exhibiting regions 45 may be formed with an interval in the width direction of the pressure-sensitive adhesive label 10 and that the respective pressure-sensitive adhesive strength non-exhibiting regions 45 may be formed on the inner side away from lateral both end portions 10b as label edges of the pressure-sensitive adhesive label 10 by a predetermined distance or more.

### (Discharge Mechanism)

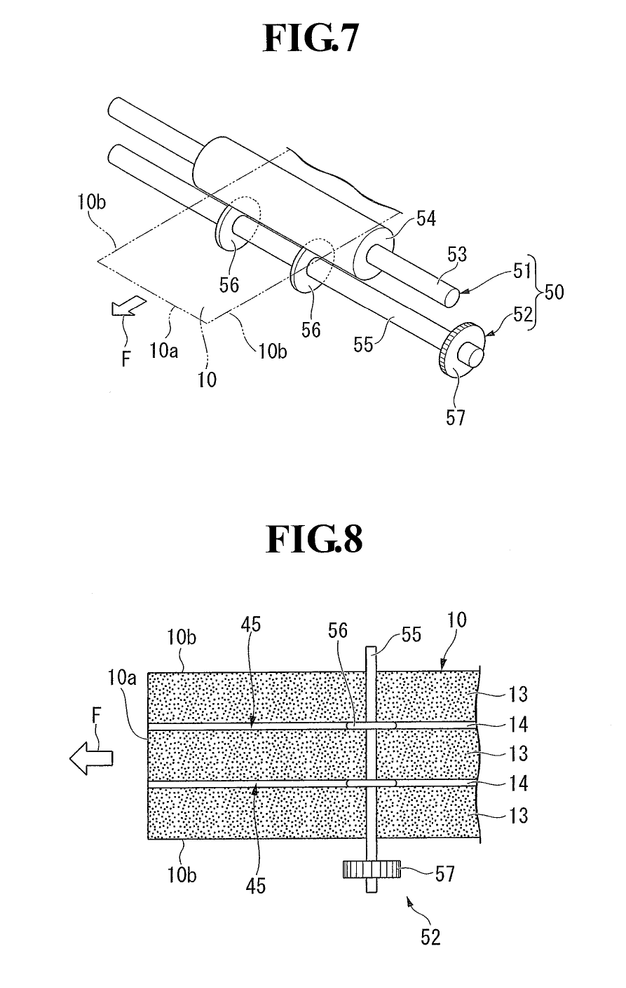

As illustrated in FIGS. 1 and 7, the discharge mechanism 50 includes a first discharge member 51 placed on the front surface side of the pressure-sensitive adhesive label 10 and a second discharge member 52 placed on the rear surface side of the pressure-sensitive adhesive label 10. The discharge mechanism 50 conveys the pressure-sensitive adhesive label 10 to the discharge position S on the downstream side while sandwiching the pressure-sensitive adhesive label 10 between the first discharge member 51 and the second discharge member 52.

The first discharge member 51 includes a first shaft member 53 extending in the width direction of the pressure-sensitive adhesive label 10 and a first discharge roller 54 mounted onto the first shaft member 53. The first shaft member 53 is supported by a support member (not shown) so that both end portions of the first shaft member 53 are rotatable. The first discharge roller 54 is a rubber roller formed to be wider than at least the pressure-sensitive adhesive label 10, and is a driven roller that rotates along with the conveyance of the pressure-sensitive adhesive label 10.

The second discharge member 52 includes a second shaft member 55 placed in parallel to and opposed to the first shaft member 53 across the pressure-sensitive adhesive label 10, and second discharge rollers (discharge rollers) 56 mounted onto the second shaft member 55. The second shaft member 55 is supported by a support member (not shown) so that both end portions of the second shaft member 55 are rotatable. A drive gear 57 is fixed to one end portion side of the second shaft member 55. Then, the second shaft member 55 rotates when rotational force is transmitted thereto from a drive source (motor or the like) (not shown) via the drive gear 57. Note that, the operation of the drive source is controlled by the control part 39.

The number of the second discharge rollers 56 provided is two corresponding to the number of the pressure-sensitive adhesive strength non-exhibiting regions 45 to be formed. As illustrated in FIGS. 7 and 8, the second discharge rollers 56 are placed with the same interval as that of the pressure-sensitive adhesive strength non-exhibiting regions 45 in the width direction of the pressure-sensitive adhesive label 10. Each of the second discharge rollers 56 is a driving roller that rotates along with the rotation of the second shaft member 55 while sandwiching the pressure-sensitive adhesive label 10 with the first discharge roller 54 of the first discharge member 51 via the pressure-sensitive adhesive strength non-exhibiting region 45.

In other words, when the second shaft member 55 and the second discharge rollers 56 are rotated, the pressure-sensitive adhesive label 10 having exhibited pressure-sensitive adhesive strength can be conveyed to the discharge position S on the downstream side. At this time, the two second discharge rollers 56 are placed with the same interval as that of the pressure-sensitive adhesive strength non-exhibiting regions 45, and hence the second discharge rollers 56 can run relatively on the respective pressure-sensitive adhesive strength non-exhibiting regions 45 along with the conveyance of the pressure-sensitive adhesive label 10. Consequently, the pressure-sensitive adhesive label 10 can be conveyed while the second discharge rollers 56 are prevented from contacting with the pressure-sensitive adhesive layer 13.

### (Operation of Printer)

Next, a description is given of the operation of the above-mentioned printer 1. First, the printer 1 prepares to operate. Specifically, as illustrated in FIG. 1, after the roll paper R is set in the roll paper receiving portion 2, the pressure-sensitive adhesive label 10 is pulled out of the roll paper receiving portion 2, and the downstream end 10a of the pressure-sensitive adhesive label 10 is inserted between the first conveyance rollers 23. Further, necessary label information is input in advance to the control part 39. Examples of the label information include the size of the width of the pressure-sensitive adhesive label 10, printing data, and formation pattern data of the bores 15 for exhibiting pressure-sensitive adhesive strength. Then, upon the start of the operation of the printer 1, the control part 39 sequentially operates the respective components.

Then, the first conveyance rollers 23 rotate, and the pressure-sensitive adhesive label 10 is conveyed to the downstream side to be supplied to the printing unit 3. The pressure-sensitive adhesive label 10 supplied to the printing unit 3 is conveyed toward the downstream side while being sandwiched between the printing platen roller 20 and the printing thermal head 21. At this time, the printing thermal head 21 is driven to perform printing operation corresponding to printing data. In this manner, printing based on the printing data is sequentially performed on the printable layer 12 of the pressure-sensitive adhesive label 10 when the pressure-sensitive adhesive label 10 passes through between the printing platen roller 20 and the printing thermal head 21.

Subsequently, the pressure-sensitive adhesive label 10 having passed through the printing unit 3 is supplied to the cutter unit 5, and is conveyed to the downstream side while passing through between the fixed blade 25 and the movable blade 26. Then, when the pressure-sensitive adhesive label 10 has passed by a desired length, the control part 39 operates the cutter drive portion 27 so that the movable blade 26 is slid and moved toward the fixed blade 25. In this manner, the pressure-sensitive adhesive label 10 can be cut while being sandwiched between the movable blade 26 and the fixed blade 25, and hence the pressure-sensitive adhesive label 10 can be adjusted to have a desired length.

Note that, the method of detecting the passage of the pressure-sensitive adhesive label 10 by a desired length is, for example, a method involving using an optical sensor or a micro switch (not shown) or a method involving detection based on a label length dimension indicated by the label information and a calculated value of a label feed amount.

Subsequently, the pressure-sensitive adhesive label 10 having passed through the cutter unit 5 is conveyed to the downstream side by the second conveyance rollers 28 to be supplied to the pressure-sensitive adhesive strength exhibiting unit 6. Then, the pressure-sensitive adhesive label 10 is fed between the thermal head 30 and the platen roller 40, and is conveyed to the downstream side while being pressed against the thermal head 30 by the platen roller 40.

In this period, the control part 39 applies heat energy independently to the plurality of heat generating elements 31 of the thermal head 30, and hence each of those heat generating elements 31 generates heat with the amount of the applied heat energy. Consequently, the function layer 14 of the pressure-sensitive adhesive label 10 pressed against the thermal head 30 by the platen roller 40 can be locally heated only in regions in contact with the heat generating elements 31 via the protective layer 35, and the regions can be melted to form the bores 15 (see FIG. 2). When the bores 15 are formed, the pressure-sensitive adhesive layer 13 is exposed through the bores 15, and hence the pressure-sensitive adhesive strength can be exhibited. Then, the application of heat energy to the plurality of heat generating elements 31 is repeated along with the conveyance of the pressure-sensitive adhesive label 10 by the platen roller 40. In this manner, the pressure-sensitive adhesive strength can be exhibited in a desired region of the pressure-sensitive adhesive label 10.

By the way, in order to exhibit the pressure-sensitive adhesive strength, the control part 39 controls not to apply heat energy to specific heat generating elements 31 so that the function layer 14 may be continuously left from the downstream end 10a of the pressure-sensitive adhesive label 10 along the conveyance direction as illustrated in FIG. 6. In this manner, the two pressure-sensitive adhesive strength non-exhibiting regions 45 that extend from the downstream end 10a along the conveyance direction can be formed at the same time when the pressure-sensitive adhesive strength is exhibited.

Then, the pressure-sensitive adhesive label 10 having exhibited pressure-sensitive adhesive strength is supplied between the first discharge member 51 and the second discharge member 52 of the discharge mechanism 50. Then, the pressure-sensitive adhesive label 10 can be conveyed by the rotation of the second discharge rollers 56 of the second discharge member 52 to the discharge position S located on the downstream side while being sandwiched between the second discharge rollers 56 and the first discharge roller 54 of the first discharge member 51. At this time, as illustrated in FIG. 8, the second discharge roller 56 sandwiches the pressure-sensitive adhesive label 10 with the first discharge roller 54 via the pressure-sensitive adhesive strength non-exhibiting region 45 and hence does not contact with the pressure-sensitive adhesive layer 13. In addition, the second discharge roller 56 runs relatively on the pressure-sensitive adhesive strength non-exhibiting region 45 along with the conveyance of the pressure-sensitive adhesive label 10, and hence the pressure-sensitive adhesive label 10 can be stably conveyed to the discharge position S and discharged while being prevented from adhering to the second discharge roller 56.

### (Function and Effect)

According to the printer 1 described in this embodiment, unlike the conventional one, the contact itself between the pressure-sensitive adhesive layer 13 and the second discharge roller 56 can be prevented, and hence, after the pressure-sensitive adhesive strength is exhibited, the pressure-sensitive adhesive label 10 can be stably conveyed without causing any conveyance failure over the lapse of time and can be reliably discharged. Consequently, a high-quality pressure-sensitive adhesive label 10 can be issued.

In particular, the two second discharge rollers 56 are used, and hence the pressure-sensitive adhesive label 10 can be more stably conveyed. In addition, the pressure-sensitive adhesive strength non-exhibiting regions 45 are formed on the inner side away from the lateral both end portions 10b of the pressure-sensitive adhesive label 10, and hence it is possible to prevent the peeling of the label edges (lateral both end portions 10b) when the issued pressure-sensitive adhesive label 10 is stuck onto a target. Consequently, the quality of the pressure-sensitive adhesive label 10 can be enhanced even in this regard.

Note that, it is preferred that the two pressure-sensitive adhesive strength non-exhibiting regions 45 be formed on the inner side at positions 5 mm or more away from the lateral both end portions 10b of the pressure-sensitive adhesive label 10.

Further, the configuration is simple because the second discharge rollers 56 are simply placed correspondingly to the pressure-sensitive adhesive strength non-exhibiting regions 45, and hence the configuration can be simplified without the need to employ a special configuration or the like. Consequently, the pressure-sensitive adhesive strength exhibiting unit 6 can be realized without increasing the size and cost.

In addition, according to the printer 1 in this embodiment, not only the pressure-sensitive adhesive label 10 can be cut to a desired length by the cutter unit 5, but also desired information can be stably printed on the printable layer 12 before the pressure-sensitive adhesive strength is exhibited by the pressure-sensitive adhesive strength exhibiting unit 6, and hence clear printing can be performed. A high-quality pressure-sensitive adhesive label 10 can be obtained even in this regard.

### (Modified Example of Embodiment)

Note that, in the above-mentioned embodiment, as illustrated in FIG. 6, the heat generating elements 31 are applied with heat energy so that the pressure-sensitive adhesive strength can be exhibited in the region other than the two pressure-sensitive adhesive strength non-exhibiting regions 45, but the present invention is not limited to this case. The pressure-sensitive adhesive strength may be exhibited in a part of the region at least other than the two pressure-sensitive adhesive strength non-exhibiting regions 45.

Further, in the above-mentioned embodiment, the two pressure-sensitive adhesive strength non-exhibiting regions 45 are formed, but the number of the pressure-sensitive adhesive strength non-exhibiting regions 45 is not limited to two but may be appropriately changed in accordance with the lateral width of the pressure-sensitive adhesive label 10. For example, in the case of a pressure-sensitive adhesive label 10 having a small lateral width of approximately 30 mm, only one pressure-sensitive adhesive strength non-exhibiting region 45 may be formed at the center portion in the lateral width direction, and in the case of a pressure-sensitive adhesive label 10 having a large lateral width of approximately 120 mm, three or more pressure-sensitive adhesive strength non-exhibiting regions 45 may be formed with intervals in the width direction. Note that, the second discharge rollers 56 only need to be provided in number corresponding to the number of the pressure-sensitive adhesive strength non-exhibiting regions 45 to be formed.

Further, it is preferred that the formation width of the pressure-sensitive adhesive strength non-exhibiting region 45 be as small as 5 mm or less. With this, a large region for exhibiting the pressure-sensitive adhesive strength can be easily ensured accordingly, and the pressure-sensitive adhesive strength can be more easily enhanced. In the case where the formation width of the pressure-sensitive adhesive strength non-exhibiting region 45 is more than 5 mm, when the pressure-sensitive adhesive label 10 is stuck onto an adherend such as a commercial product, the pressure-sensitive adhesive strength non-exhibiting region 45 is more likely to be lifted from the adherend so that a gap occurs between the pressure-sensitive adhesive label 10 and the adherend. Thus, in the case where the pressure-sensitive adhesive label 10 is used as an address label for logistics use or the like, the pressure-sensitive adhesive label 10 itself may be torn when something is caught in the gap due to rubbing of parcels or the like.

Further, in the above-mentioned embodiment, the printer 1 includes the first conveyance rollers 23 and the second conveyance rollers 28, but those conveyance rollers are not essential components and may not be provided. Alternatively, three or more conveyance rollers may be provided depending on the conveyance path or the like. Further, the installation positions of the conveyance rollers may be freely set. Further, in the above-mentioned embodiment, the cutter unit 5 is placed on the upstream side of the pressure-sensitive adhesive strength exhibiting unit 6, but is not limited to this position. For example, the cutter unit 5 may be placed between the thermal head 30 and the platen roller 40, and the discharge mechanism 50. Note that, it is more preferred to place the cutter unit 5 on the upstream side of the pressure-sensitive adhesive strength exhibiting unit 6 because the pressure-sensitive adhesive label 10 can be cut before the pressure-sensitive adhesive strength is exhibited.

Further, in the above-mentioned embodiment, the first discharge roller 54 is a driven roller, and the second discharge roller 56 is a driving roller, but the present invention is not limited to this case. For example, the first discharge roller 54 may be a driving roller, and the second discharge roller 56 may be a driven roller. Alternatively, both the first discharge roller 54 and the second discharge roller 56 may be driving rollers. In any case, the pressure-sensitive adhesive label 10 only needs to be conveyed to the downstream side while being sandwiched between the first discharge member 51 and the second discharge member 52. Further, in the case where the second discharge roller 56 is a driving roller, the first discharge member 51 does not need to be a roller or the like. For example, a guide plate for guiding the pressure-sensitive adhesive label 10 to the downstream side while being brought into sliding contact with the printable layer 12 of the pressure-sensitive adhesive label 10 may be employed as the first discharge member 51.

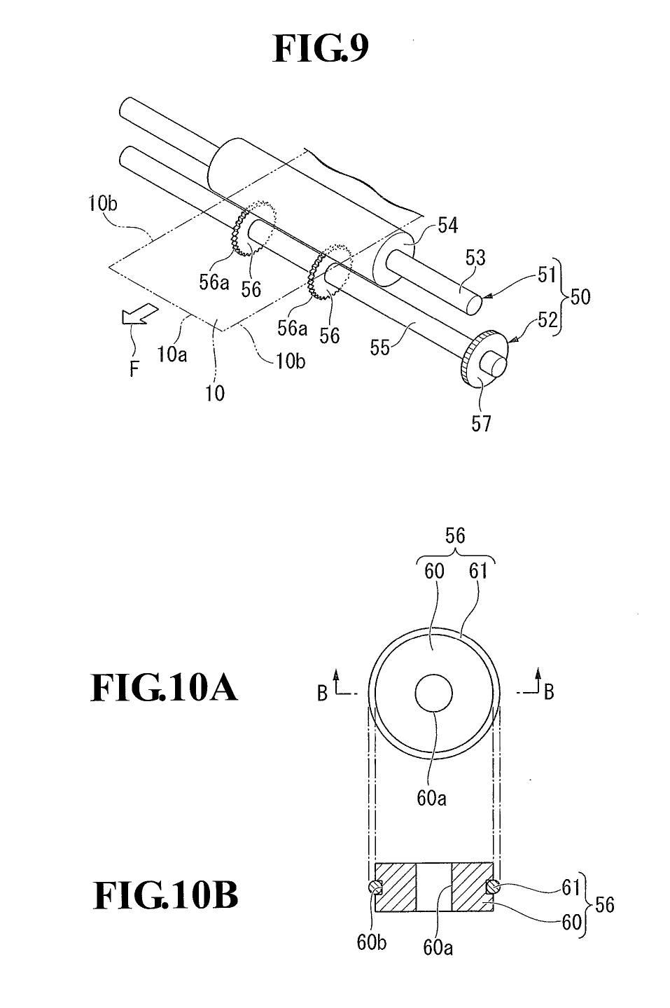

Further, in the above-mentioned embodiment, as illustrated in FIG. 9, the outer peripheral surface of the second discharge roller 56 may be an uneven surface 56a on which irregularities are repeated in the circumferential direction over the entire circumference. Note that, FIG. 9 illustrates the case where the second discharge roller 56 is formed into a gear shape by the uneven surface 56a on which concave portions and convex portions having triangular shapes in side view are repeated in the circumferential direction. Note that, an uneven surface 56a on which concave portions and convex portions having semicircular shapes in side view are repeated in the circumferential direction may be employed.

As described above, the outer peripheral surface of the second discharge roller 56 is the uneven surface 56a, and hence the second discharge roller 56 can be brought into contact with the pressure-sensitive adhesive label 10 in the state of biting into the pressure-sensitive adhesive strength non-exhibiting region 45. Consequently, a stable conveyance of the pressure-sensitive adhesive label 10 can be easily performed without causing a slippage or the like. In addition, in this case, a trace of the uneven surface 56a (a running trace of the second discharge roller 56) is likely to remain on the pressure-sensitive adhesive label 10 as a dotted line. Consequently, it can be determined whether or not the installation position of the second discharge roller 56 with respect to the pressure-sensitive adhesive label 10 having the pressure-sensitive adhesive strength non-exhibiting region 45 formed therein is proper based on whether or not the trace is formed along the pressure-sensitive adhesive strength non-exhibiting region 45. If the trace deviates from the pressure-sensitive adhesive strength non-exhibiting region 45, the position of the second discharge roller 56 is adjusted so that the trace may be formed on the pressure-sensitive adhesive strength non-exhibiting region 45. In this manner, the pressure-sensitive adhesive label 10 can be more stably conveyed.

In addition, as illustrated in FIGS. 10A and 10B, the second discharge roller 56 may be formed of a disc-like roller main body 60 and an O ring (annular elastic ring) 61 mounted on the outer peripheral surface of the roller main body 60. The roller main body 60 is thick and ensures the rigidity, and a coupling hole 60a for coupling to the second shaft member 55 is formed at the center portion. Further, an annular groove 60b is formed in the outer peripheral surface of the roller main body 60 at the center portion in the thickness direction. Then, the O ring 61 is fixedly fitted into the annular groove 60b. In this case, the outer diameter of the O ring 61 is larger than the outer diameter of the roller main body 60, and hence only the region of the O ring 61 is brought into contact with the pressure-sensitive adhesive strength non-exhibiting region 45.

In the case where the second discharge roller 56 is configured as described above, only the region of the O ring 61 can be brought into contact with the pressure-sensitive adhesive strength non-exhibiting region 45, and hence the formation width of the pressure-sensitive adhesive strength non-exhibiting region 45 can be reduced correspondingly to the thickness of the O ring 61. Consequently, a large region for exhibiting the pressure-sensitive adhesive strength can be easily ensured accordingly, and the pressure-sensitive adhesive strength can be more easily enhanced. On the other hand, the rigidity of the roller main body 60 can be ensured, and hence the reliability of the second discharge roller 56 can be easily enhanced. Further, the O ring 61 and the pressure-sensitive adhesive strength non-exhibiting region 45 can be brought into contact with each other at an appropriate contact resistance by utilizing the elastic property of the O ring 61, and hence a stable conveyance of the pressure-sensitive adhesive label 10 can be easily performed without causing a slippage or the like.

By the way, the pressure-sensitive adhesive strength exhibiting unit 6 in the above-mentioned embodiment is configured so that the second discharge roller 56 runs relatively on the pressure-sensitive adhesive strength non-exhibiting region 45 that is formed at the same time when the pressure-sensitive adhesive strength is exhibited in the pressure-sensitive adhesive label 10, and hence the second discharge roller 56 is prevented from contacting with the pressure-sensitive adhesive layer 13 to suppress a conveyance failure over the lapse of time. In order to obtain the function and effect, the relative relationship between the position of the pressure-sensitive adhesive strength non-exhibiting region 45 and the position of the second discharge roller 56 in the width direction of the pressure-sensitive adhesive label 10 is important, and it is necessary to align the pressure-sensitive adhesive strength non-exhibiting region 45 and the second discharge roller 56 with each other.

For example, the alignment is necessary when the relative positions of the pressure-sensitive adhesive strength non-exhibiting region 45 and the second discharge roller 56 are deviated due to a mounting position error of the thermal head 30 with respect to the head support member 41, a formation position error of the heat generating element 31, a mounting error of the head support member 41 itself, or other such errors. Further, even once the alignment is performed, alignment needs to be performed again when the thermal head 30 is replaced with another one, when the position of the second discharge roller 56 is moved for the use of a pressure-sensitive adhesive label 10 having a different width, when the formation position of the pressure-sensitive adhesive strength non-exhibiting region 45 is changed, or in other such cases.

It is therefore preferred that the second discharge roller 56 be easily movable with respect to the second shaft member 55 and that the second discharge roller 56 can be fixed to the second shaft member 55 at an arbitrary position. For example, it is possible to employ a configuration in which the second discharge roller 56 is mounted onto the second shaft member 55 via a one-touch clip member or the like capable of switching between the function of sandwiching the second shaft member 55 and the function of releasing the sandwiching. Note that, the present invention is not limited to this manual configuration, and, for example, the position of the second discharge roller 56 may be electrically changed by using an actuator or the like.

This configuration enables the position of the second discharge roller 56 to be finely adjusted in accordance with the position of the pressure-sensitive adhesive strength non-exhibiting region 45 formed in the pressure-sensitive adhesive label 10. Consequently, the relative positions of the pressure-sensitive adhesive strength non-exhibiting region 45 and the second discharge roller 56 in the width direction of the pressure-sensitive adhesive label 10 can be easily aligned with each other.

Alternatively, the application pattern of the heat generating elements 31 may be changed in accordance with the position of the second discharge roller 56 so as to finely adjust the formation position of the pressure-sensitive adhesive strength non-exhibiting region 45. Also in this case, the relative positions of the pressure-sensitive adhesive strength non-exhibiting region 45 and the second discharge roller 56 in the width direction of the pressure-sensitive adhesive label 10 can be easily aligned with each other. In addition, the alignment may be performed by a combination of the position adjustment of the second discharge roller 56 and the formation position adjustment of the pressure-sensitive adhesive strength non-exhibiting region 45 described above.

Now, a more specific description is given of the alignment method.

### (First Alignment Method)

The control part 39 may control the respective components so that the pressure-sensitive adhesive label 10 stops once before reaching the discharge mechanism 50 after passing through between the thermal head 30 and the platen roller 40. This configuration enables the displacement amount between the position of the pressure-sensitive adhesive strength non-exhibiting region 45 and the position of the second discharge rollers 56 to be easily checked, and hence an accurate adjustment of the position of the second discharge roller 56 can be easily performed. In this manner, the relative positions of the pressure-sensitive adhesive strength non-exhibiting region 45 and the second discharge roller 56 in the width direction of the pressure-sensitive adhesive label 10 can be accurately aligned with each other.

### (Second Alignment Method)

Alternatively, a dedicated label (not shown) dedicated for alignment, which has the same configuration as that of the pressure-sensitive adhesive label 10, may be prepared and used for alignment. In this case, for example, the printable layer 12 of the dedicated label is printed in advance with a mark such as a scale in the width direction. Then, the thermal head 30 is used to form a pressure-sensitive adhesive strength non-exhibiting region 45 in the dedicated label. In this manner, the position of the second discharge roller 56 can be aligned with the position of the pressure-sensitive adhesive strength non-exhibiting region 45 by using the mark as an indicator, and hence the accurate position adjustment of the second discharge roller 56 can be easily performed. In this manner, the relative positions of the pressure-sensitive adhesive strength non-exhibiting region 45 and the second discharge roller 56 in the width direction of the pressure-sensitive adhesive label 10 can be accurately aligned with each other via the mark. Note that, the mark does not need to be printed on the dedicated label in advance, and a mark may be printed on the printable layer 12 of the dedicated label by using the printing unit 3.

### (Third Alignment Method)

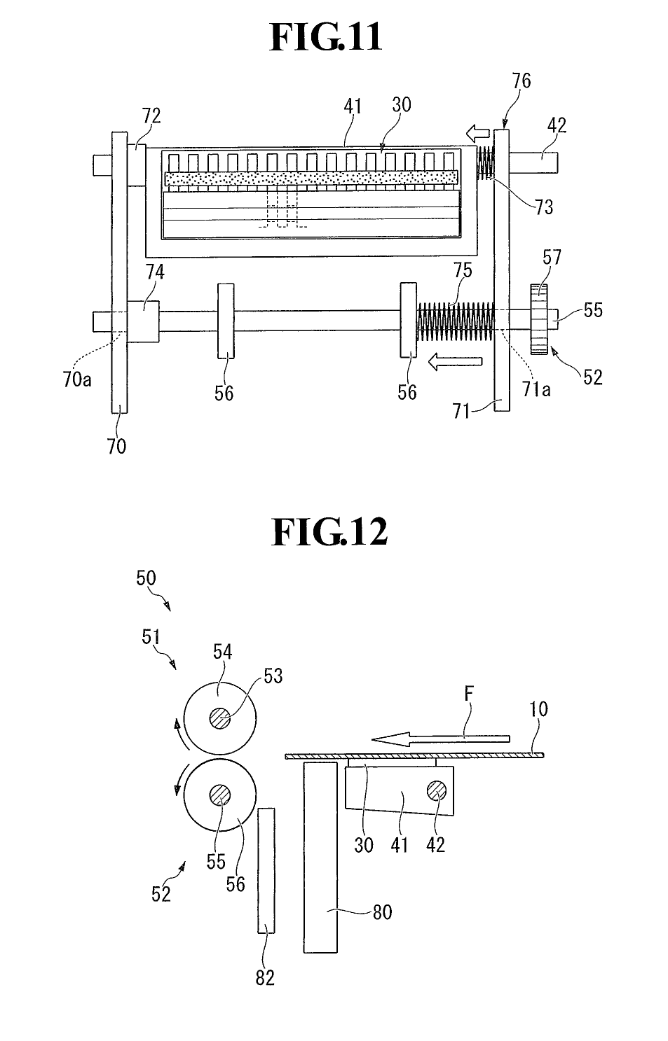

Alternatively, the thermal head 30 and the second discharge member 52 may be coupled to each other by using a coupling member in a state in which the second discharge roller 56 is positioned with respect to the thermal head 30 along the width direction of the pressure-sensitive adhesive label 10. Specifically, as illustrated in FIG. 11, a first plate member 70 and a second plate member 71 are fixed to the shaft 42 that supports the head support member 41 in a pivotable manner, so as to oppose to each other across the head support member 41. The first plate member 70 and the second plate member 71 extend toward the second shaft member 55 of the second discharge member 52. Then, the second shaft member 55 is inserted into through holes 70a and 71a formed respectively in the first plate member 70 and the second plate member 71.

As described above, the shaft 42 is fixed to the first plate member 70 and the second plate member 71, but the head support member 41 is movable with respect to the shaft 42. Further, an abutment part 72 is fixed to the shaft 42 so as to abut the first plate member 70, and a bias member 73 is fitted on the shaft 42 between the head support member 41 and the second plate member 71. The bias member 73 is, for example, a coil spring, and biases the head support member 41 toward the first plate member 70. In this manner, the head support member 41 abuts the abutment part 72 and is positioned with respect to the first plate member 70 via the abutment part 72.

On the other hand, an abutment part 74 is also fixed to the second shaft member 55, and a bias member 75 is fitted on the second shaft member 55 between the second discharge roller 56 and the second plate member 71. The bias member 75 is, for example, a coil spring, and biases the whole second discharge member 52 toward the first plate member 70. In this manner, the abutment part 74 abuts the first plate member 70, and the second discharge member 52 is positioned with respect to the first plate member 70 via the abutment part 74.

In other words, the thermal head 30 and the second discharge member 52 are positioned with respect to the common first plate member 70. Note that, the first plate member 70, the second plate member 71, the abutment parts 72 and 74, and the bias members 73 and 75 constitute the coupling member 76.

In the case of the above-mentioned configuration, the second discharge roller 56 can be positioned with respect to the thermal head 30 along the width direction of the pressure-sensitive adhesive label 10 by the coupling member 76. Consequently, an accurate alignment between the position of the pressure-sensitive adhesive strength non-exhibiting region 45 formed by the thermal head 30 and the position of the second discharge roller 56 can be easily performed in the width direction of the pressure-sensitive adhesive label 10.

### (Fourth Alignment Method)

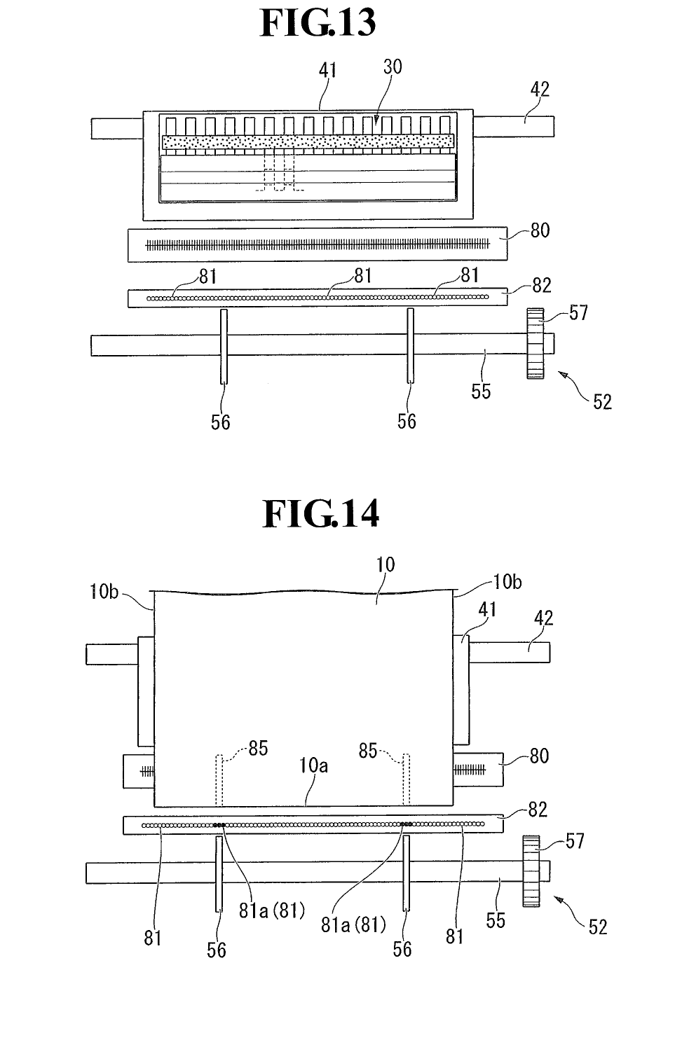

Alternatively, the installation position of the second discharge roller 56 may be indicated by LED display. Specifically, as illustrated in FIGS. 12 and 13, a read sensor 80 for reading a surface state of the pressure-sensitive adhesive label 10 and a display unit 82 having a plurality of LEDs 81 arranged along the width direction of the pressure-sensitive adhesive label 10 are placed between the thermal head 30 and the second discharge member 52.

The read sensor 80 is placed on the rear surface side of the pressure-sensitive adhesive label 10 on the downstream side of the thermal head 30. The read sensor 80 is, for example, a line image sensor extending in the width direction of the pressure-sensitive adhesive label 10. The display unit 82 is placed on the rear surface side of the pressure-sensitive adhesive label 10 on the downstream side of the read sensor 80. In the display unit 82, the plurality of LEDs 81 whose emissions are individually controlled by the control part 39 are arranged in line at narrow pitches.

Further, the control part 39 in this case is capable of switching between a mode for causing the pressure-sensitive adhesive label 10 to exhibit pressure-sensitive adhesive strength (pressure-sensitive adhesive strength exhibiting mode) and a position adjustment mode for adjusting the position of the second discharge roller 56. For example, a hard switch for causing the CPU 38 to enter the position adjustment mode is built in the control part 39, and, when the hard switch is operated, the mode can be switched to the position adjustment mode. Note that, the present invention is not limited thereto, and, for example, the function may be assigned so that the mode shifts to the position adjustment mode by long pressing of a single switch, simultaneous pressing of two switches, or other such methods. Then, when entering the position adjustment mode, the control part 39 controls the application of heat energy to, among the plurality of heat generating elements 31 of the thermal head 30, a heat generating element 31 that has not been applied with heat energy for forming the pressure-sensitive adhesive strength non-exhibiting region 45.

Further, when entering the position adjustment mode, the read sensor 80 reads the surface state of the pressure-sensitive adhesive label 10, and identifies the position of the heat generating element 31 applied with heat energy based on a change in the read surface state and outputs the identified position to the control part 39. Then, the control part 39 controls the display unit 82 so that, among the plurality of LEDs 81 of the display unit 82, an LED 81 that is located at the same position in the width direction of the pressure-sensitive adhesive label 10 as the position of the heat generating element 31 identified by the read sensor 80 may be turned on.

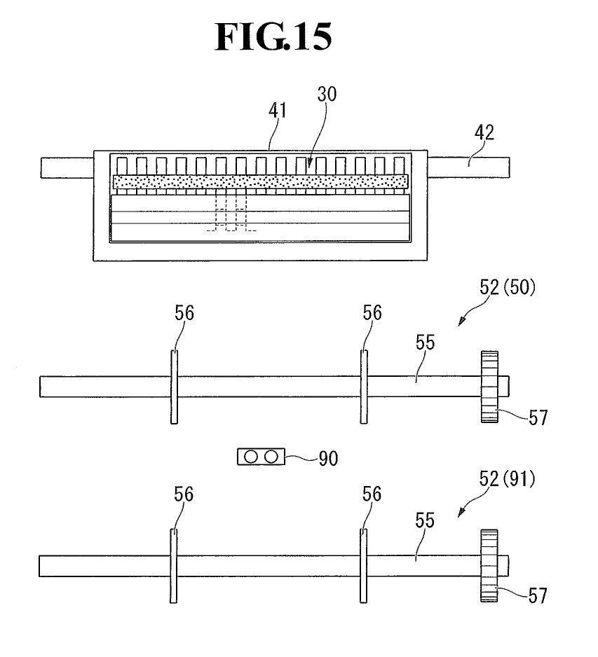

A description is now given of the case where the alignment is performed by the configuration described above. Note that, the case where the alignment is performed in the state in which the pressure-sensitive adhesive label 10 is vertically inverted is hereinafter exemplified. First, after the mode is switched to the position adjustment mode, the vertically inverted pressure-sensitive adhesive label 10 is supplied between the thermal head 30 and the platen roller 40. Then, the control unit 39 applies heat energy to a heat generating element 31 that has not been applied with heat energy when the pressure-sensitive adhesive strength is exhibited. In this manner, as illustrated in FIG. 14, a vertical line 85 corresponding to the formation position of the pressure-sensitive adhesive strength non-exhibiting region 45 can be printed on the printable layer 12 of the pressure-sensitive adhesive label 10. Note that, in this case, printing is performed so that at least the vertical line 85 may appear on the downstream end 10a of the pressure-sensitive adhesive label 10.

Then, when the pressure-sensitive adhesive label 10 is conveyed to the downstream side to reach the read sensor 80, the read sensor 80 identifies the position of the vertical line 85 (that is, the position of the heat generating element 31 applied with heat energy at that time) based on the change in the surface state of the pressure-sensitive adhesive label 10, and outputs the identified position to the control part 39. Then, the control part 39 operates the display unit 82 so that, among the plurality of LEDs 81, an LED 81a that is located at the same position in the width direction of the pressure-sensitive adhesive label 10 as the position of the heat generating element 31 identified by the read sensor 80 (an LED 81 located at the same position in the width direction of the pressure-sensitive adhesive label 10 as the vertical line 85) is turned on.

In this manner, by checking the position of the turned-on LED 81a, the formation position of the pressure-sensitive adhesive strength non-exhibiting region 45 can be accurately grasped. Consequently, by aligning the position of the second discharge roller 56 with the position of the turned-on LED 81a, the pressure-sensitive adhesive strength non-exhibiting region 45 and the second discharge roller 56 can be aligned with each other with high accuracy.

Note that, the LED 81 may be turned on by lighting or flashing. Further, although the pressure-sensitive adhesive label 10 is vertically inverted in the position adjustment mode, the pressure-sensitive adhesive label 10 may not be vertically inverted. In this case, the pressure-sensitive adhesive layer 13 can be exposed in a line shape on the rear surface side of the pressure-sensitive adhesive label 10. Thus, the position of the linearly-exposed pressure-sensitive adhesive layer 13 can be identified by the read sensor 80, and hence the LED 81 corresponding to the identified position is turned on. Even in this case, the pressure-sensitive adhesive strength non-exhibiting region 45 and the second discharge roller 56 can be aligned with each other with high accuracy. In this case, the conveyance of the pressure-sensitive adhesive label 10 is stopped before the linearly-exposed pressure-sensitive adhesive layer 13 contacts with the second discharge roller 56.

### (Fifth Alignment Method)

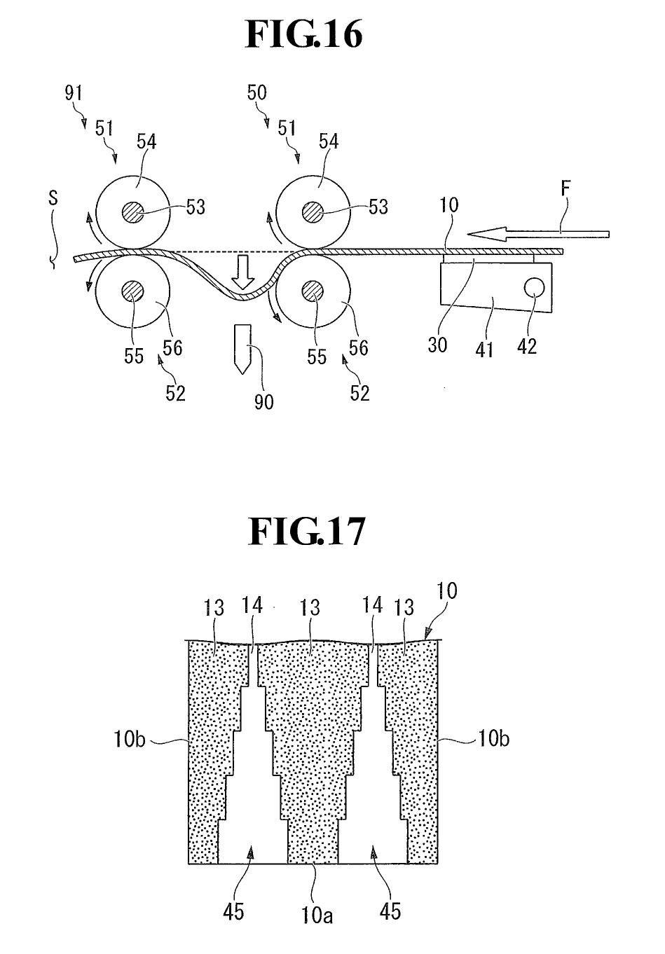

Alternatively, the alignment may be performed by using the presence/absence of sagging of the pressure-sensitive adhesive label 10 caused by sticking to the second discharge roller 56. Specifically, as illustrated in FIGS. 15 and 16, a detection part 90 for detecting the sagging of the pressure-sensitive adhesive label 10 that has been conveyed by the discharge mechanism 50 is placed on the downstream side of the discharge mechanism 50. Note that, in the illustrated example, a second discharge mechanism 91 having the same configuration as that of the discharge mechanism 50 is placed on the downstream side of the detection part 90. A description of the second discharge mechanism 91 is therefore omitted.

The detection part 90 is placed on the rear surface side of the pressure-sensitive adhesive label 10, and is a sensor for detecting in a contact or noncontact manner the occurrence of sagging of the pressure-sensitive adhesive label 10 caused by sticking to the second discharge roller 56 of the discharge mechanism 50. Examples of this kind of sensors include a photosensor and a microsensor.

How to perform the alignment by this configuration is now described. Note that, the second discharge roller 56 of the discharge mechanism 50 and the second discharge roller 56 of the second discharge mechanism 91 are located at the same position in the width direction of the pressure-sensitive adhesive label 10. In this case, when the pressure-sensitive adhesive strength non-exhibiting region 45 and the second discharge roller 56 of the discharge mechanism 50 are aligned with each other, the pressure-sensitive adhesive label 10, which is conveyed toward the discharge position S by the discharge mechanism 50, is conveyed to the second discharge mechanism 91 without sagging, and is then conveyed to the further downstream side by the second discharge mechanism 91.

On the other hand, when the position of the pressure-sensitive adhesive strength non-exhibiting region 45 and the position of the second discharge roller 56 of the discharge mechanism 50 are misaligned with each other in the width direction of the pressure-sensitive adhesive label 10, the pressure-sensitive adhesive layer 13 of the pressure-sensitive adhesive label 10 sticks to the second discharge roller 56. Thus, the pressure-sensitive adhesive label 10 is rolled around the second discharge roller 56, and sags as illustrated in FIG. 16. Then, the detection part 90 detects the sagging of the pressure-sensitive adhesive label 10, and outputs the detection to the control part 39. Consequently, the control part 39 can easily determine whether or not the pressure-sensitive adhesive strength non-exhibiting region 45 and the second discharge roller 56 are properly aligned with each other based on the presence/absence of the detection by the detection part 90, and the position of the second discharge roller 56 can be easily adjusted based on the presence/absence of the detection.

Note that, in the case where the detection part 90 detects the sagging, it is preferred to immediately stop the output of the thermal head 30 and the operation of the discharge mechanism 50 and to continue rotating the second discharge roller 56 of the second discharge mechanism 91. In this manner, the rolling of the pressure-sensitive adhesive label 10 can be released, and the jammed pressure-sensitive adhesive label 10 can be easily taken out.

By the way, in the case where the detection part 90 is used, the control part 39 may be configured to switch between a mode for causing the pressure-sensitive adhesive label 10 to exhibit pressure-sensitive adhesive strength (pressure-sensitive adhesive strength exhibiting mode) and a position adjustment mode for adjusting the position of the second discharge roller 56. Then, when entering the position adjustment mode, the control part 39 controls the application of heat energy to the heat generating elements 31 so that the pressure-sensitive adhesive strength non-exhibiting region 45 may be formed in the state in which the lateral width is reduced in a stepwise manner from the downstream end 10a of the pressure-sensitive adhesive label 10 as illustrated in FIG. 17.

In this case, when the mode is switched to the position adjustment mode, the control part 39 applies heat energy to the heat generating elements 31 so as to form not a pressure-sensitive adhesive strength non-exhibiting region 45 having a constant width but the stepwise pressure-sensitive adhesive strength non-exhibiting region 45 whose lateral width is reduced in a stepwise manner from the downstream end 10a of the pressure-sensitive adhesive label 10 as illustrated in FIG. 17. Consequently, how much the position of the second discharge roller 56 deviates can be grasped based on the lateral width of the pressure-sensitive adhesive strength non-exhibiting region 45 at the time of the detection by the detection part 90, and hence the position adjustment can be easily performed.

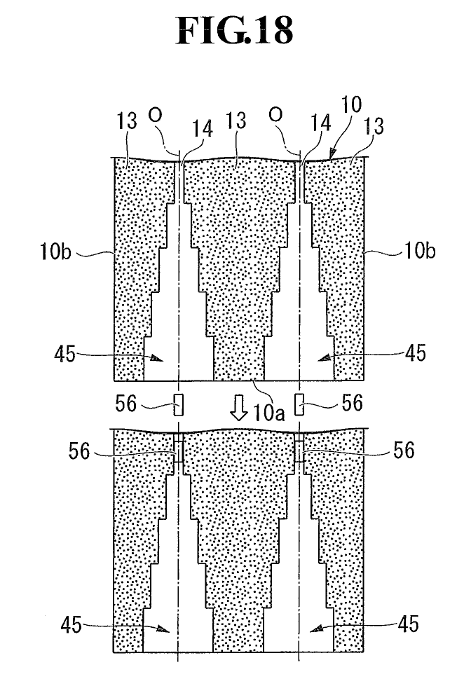

Now, a detailed description is given of the above-mentioned case. As illustrated in FIG. 18, when the position of the pressure-sensitive adhesive strength non-exhibiting region 45 and the position of the second discharge roller 56 are aligned with each other, the second discharge roller 56 is located on a center line O of the pressure-sensitive adhesive strength non-exhibiting region 45. In this case, the second discharge roller 56 runs on the pressure-sensitive adhesive strength non-exhibiting region 45 without contacting with the pressure-sensitive adhesive layer 13. Consequently, the detection part 90 detects nothing, and hence it can be determined that the pressure-sensitive adhesive strength non-exhibiting region 45 and the second discharge roller 56 are properly aligned with each other.

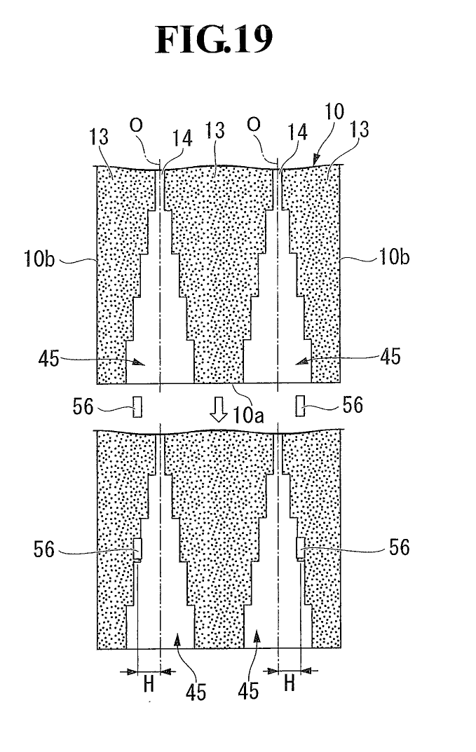

On the other hand, as illustrated in FIG. 19, when the position of the pressure-sensitive adhesive strength non-exhibiting region 45 and the position of the second discharge roller 56 are misaligned from each other, the second discharge roller 56 is not located on the center line O of the pressure-sensitive adhesive strength non-exhibiting region 45. Consequently, in this case, the second discharge roller 56 comes into contact with the pressure-sensitive adhesive layer 13 on the way along with the conveyance of the pressure-sensitive adhesive label 10, with the result that the pressure-sensitive adhesive label 10 is rolled around the second discharge roller 56. Then, the pressure-sensitive adhesive label 10 sags, and the detection part 90 detects the sagging.

In this case, based on the lateral width of the pressure-sensitive adhesive strength non-exhibiting region 45, which is reduced in a stepwise manner, a displacement amount H indicating how much the second discharge roller 56 deviates from the center line O can be easily grasped. Consequently, simply by moving the second discharge roller 56 by the displacement amount H, the position of the pressure-sensitive adhesive strength non-exhibiting region 45 and the position of the second discharge roller 56 can be aligned with each other, which further facilitates the alignment work.

Further, it is preferred to reduce the lateral width of the pressure-sensitive adhesive strength non-exhibiting region 45 in a stepwise manner so that the lateral width may be changed in a stepwise manner in association with the length from the downstream end 10a of the pressure-sensitive adhesive label 10 along the conveyance direction. In this case, when the detection part 90 detects the sagging, the lateral width of the pressure-sensitive adhesive strength non-exhibiting region 45 at the time of the detection can be calculated by the control part 39 based on the length of the pressure-sensitive adhesive label 10 from the downstream end 10a of the pressure-sensitive adhesive label 10 to the detected position. Consequently, the displacement amount H indicating how much the position of the second discharge roller 56 deviates from the center line O can be quickly grasped, which further facilitates the alignment work.

Note that, the displacement amount H may be notified to an operator by being displayed on a display part such as a liquid crystal screen or by being printed on the printable layer 12 of the pressure-sensitive adhesive label 10.

The technical scope of the present invention is not limited to the above-mentioned embodiment, but various modifications can be made without departing from the spirit of the present invention.

What is claimed is:

1. A pressure-sensitive adhesive strength exhibiting unit configured to heat a pressure-sensitive adhesive label to exhibit pressure-sensitive adhesive strength thereof, the pressure-sensitive adhesive label including a printable layer and a pressure-sensitive adhesive layer, the printable layer being provided on one surface of a base, the pressure-sensitive adhesive layer being provided on another surface of the base and covered by a non-pressure-sensitive-adhesive function layer, the pressure-sensitive adhesive strength exhibiting unit including:
a thermal head including a plurality of heat generating elements arranged along a width direction of the pressure-sensitive adhesive label, the thermal head being configured to heat the pressure-sensitive adhesive label, which is conveyed along a conveyance direction, from the pressure-sensitive adhesive layer side to form holes in the non-pressure-sensitive-adhesive function layer by the plurality of heat generating elements, to thereby expose the pressure-sensitive adhesive layer;
a control part for applying heat energy independently to the plurality of heat generating elements to control heat generation of the plurality of heat generating elements; and
a discharge mechanism placed on a downstream side of the thermal head in the conveyance direction, the discharge mechanism including a first discharge member placed on the printable layer side and a second discharge member placed on the non-pressure-sensitive-adhesive function layer side, the discharge mechanism being configured to convey the pressure-sensitive adhesive label to a discharge position located on the downstream side of the discharge mechanism while sandwiching the pressure-sensitive adhesive label between the first discharge member and the second discharge member,
wherein the control part applies the heat energy to the plurality of heat generating elements so as to form the holes and to form a pressure-sensitive adhesive strength non-exhibiting region in which the non-pressure-sensitive-adhesive function layer extends continuously from a downstream end of the pressure-sensitive adhesive label along the conveyance direction, and
the second discharge member includes a discharge roller configured to sandwich the pressure-sensitive adhesive label with the first discharge member via the pressure-sensitive adhesive strength non-exhibiting region and to run relatively on the pressure-sensitive adhesive strength non-exhibiting region along with the conveyance of the pressure-sensitive adhesive label.

2. A pressure-sensitive adhesive strength exhibiting unit according to claim 1,
wherein the control part is configured to apply the heat energy to the plurality of heat generating elements so that a plurality of the pressure-sensitive adhesive strength non-exhibiting regions is formed with intervals in the width direction of the pressure-sensitive adhesive label, and
the discharge roller is provided in number corresponding to a number of the plurality of the pressure-sensitive adhesive strength non-exhibiting regions to be formed.

3. A pressure-sensitive adhesive strength exhibiting unit according to claim 1,
wherein the control part is configured to apply the heat energy to the plurality of heat generating elements so that the pressure-sensitive adhesive strength non-exhibiting region is formed on the inner side away from lateral both end portions of the pressure-sensitive adhesive label by a predetermined distance or more.

4. A pressure-sensitive adhesive strength exhibiting unit according to claim 1,
wherein the discharge roller includes:
a disc-like roller main body; and
an annular elastic ring that is mounted on an outer peripheral surface of the disc-like roller main body and is larger in diameter than the disc-like roller main body.

5. A pressure-sensitive adhesive strength exhibiting unit according to claim 1, wherein
an outer peripheral surface of the discharge roller is an uneven surface on which irregularities are repeated in a circumferential direction over an entire circumference thereof.

6. A pressure-sensitive adhesive strength exhibiting unit according to claim 1,
wherein the pressure-sensitive adhesive strength exhibiting unit further includes
a coupling member for coupling the thermal head and the second discharge member to each other in a state in which the second discharge member is positioned relative to the thermal head along the width direction of the pressure-sensitive adhesive label.

7. A pressure-sensitive adhesive strength exhibiting unit according to claim 1, further include:
a read sensor for reading a surface state of the pressure-sensitive adhesive label; and
a display unit including a plurality of LEDs arranged along the width direction of the pressure-sensitive adhesive label,
wherein the read sensor and the display unit are placed between the thermal head and the second discharge member,
the control part is configured to switch between a pressure-sensitive adhesive strength exhibiting mode for causing the pressure-sensitive adhesive label to exhibit pressure-sensitive adhesive strength and a position adjustment mode for adjusting a position of the discharge roller, that the control part is configured to apply, when entering the position adjustment mode, heat energy to a heat generating element that has not been applied with heat energy in order to form the pressure-sensitive adhesive strength non-exhibiting region among the plurality of heat generating elements,
the read sensor is configured to read the surface state of the pressure-sensitive adhesive label when entering the position adjustment mode, and to identify a position of the heat generating element applied with the heat energy based on a change in the read surface state and output the identified position to the control part, and
the control part is configured to operate the display unit so that, among the plurality of LEDs, an LED that is placed at the same position in the width direction of the pressure-sensitive adhesive label as the position of the heat generating element identified by the read sensor is turned on.

8. A pressure-sensitive adhesive strength exhibiting unit according to claim 1, further include:
a detection part for detecting sagging of the pressure-sensitive adhesive label, the detection part being placed on the downstream side of the discharge mechanism in the conveyance direction.

9. A pressure-sensitive adhesive strength exhibiting unit according to claim 1,
wherein the control part is configured to switch between a pressure-sensitive adhesive strength exhibiting mode for exhibiting pressure-sensitive adhesive strength and a position adjustment mode for adjusting the position of the discharge roller, and that the control part be configured to apply, when entering the position adjustment mode, heat energy to the plurality of heat generating elements so that the pressure-sensitive adhesive strength non-exhibiting region is formed in a state in which a lateral width of the pressure-sensitive adhesive strength non-exhibiting region is reduced in a stepwise manner from the downstream end of the pressure-sensitive adhesive label.

10. A pressure-sensitive adhesive strength exhibiting unit according to claim 1,
wherein the control part is configured to apply heat energy to the plurality of heat generating elements so that the lateral width of the pressure-sensitive adhesive strength non-exhibiting region is changed in a stepwise manner in association with a length from the downstream end of the pressure-sensitive adhesive label along the conveyance direction, and to calculate, when the detection part detects the sagging, the lateral width of the pressure-sensitive adhesive strength non-exhibiting region at a time of the detection based on a length of the pressure-sensitive adhesive label from the downstream end of the pressure-sensitive adhesive label to a detected position.

11. A pressure-sensitive adhesive label issuing device including:
the pressure-sensitive adhesive strength exhibiting unit according to claim 1; and
a cutter unit for cutting the pressure-sensitive adhesive label to a desired length.

12. A printer includes:
the pressure-sensitive adhesive label issuing device according to claim 1; and
a printing unit for printing on the printable layer, the printing unit being placed on an upstream side of the pressure-sensitive adhesive strength exhibiting unit in the conveyance direction.

13. A pressure-sensitive adhesive strength exhibiting unit according to claim 2,
wherein the control part is configured to apply the heat energy to the plurality of heat generating elements so that the pressure-sensitive adhesive strength non-exhibiting region is formed on the inner side away from lateral both end portions of the pressure-sensitive adhesive label by a predetermined distance or more.

14. A pressure-sensitive adhesive strength exhibiting unit according to claim 13,
wherein the discharge roller includes:
a disc-like roller main body; and
an annular elastic ring that is mounted on an outer peripheral surface of the disc-like roller main body and is larger in diameter than the disc-like roller main body.

15. A pressure-sensitive adhesive strength exhibiting unit according to claim 13, wherein
an outer peripheral surface of the discharge roller is an uneven surface on which irregularities are repeated in a circumferential direction over an entire circumference thereof.

16. A pressure-sensitive adhesive strength exhibiting unit according to claim 13,
wherein the pressure-sensitive adhesive strength exhibiting unit further includes
a coupling member for coupling the thermal head and the second discharge member to each other in a state in which the second discharge member is positioned relative to the thermal head along the width direction of the pressure-sensitive adhesive label.

17. A pressure-sensitive adhesive strength exhibiting unit according to claim 16, further include:
a read sensor for reading a surface state of the pressure-sensitive adhesive label; and
a display unit including a plurality of LEDs arranged along the width direction of the pressure-sensitive adhesive label,
wherein the read sensor and the display unit are placed between the thermal head and the second discharge member,
the control part is configured to switch between a pressure-sensitive adhesive strength exhibiting mode for causing the pressure-sensitive adhesive label to exhibit pressure-sensitive adhesive strength and a position adjustment mode for adjusting a position of the discharge roller, that the control part is configured to apply, when entering the position adjustment mode, heat energy to a heat generating element that has not been applied with heat energy in order to form the pressure-sensitive adhesive strength non-exhibiting region among the plurality of heat generating elements,
the read sensor is configured to read the surface state of the pressure-sensitive adhesive label when entering the position adjustment mode, and to identify a position of the heat generating element applied with the heat energy based on a change in the read surface state and output the identified position to the control part, and
the control part is configured to operate the display unit so that, among the plurality of LEDs, an LED that is placed at the same position in the width direction of the pressure-sensitive adhesive label as the position of the heat generating element identified by the read sensor is turned on.

18. A pressure-sensitive adhesive strength exhibiting unit according to claim 16, further include:
a detection part for detecting sagging of the pressure-sensitive adhesive label, the detection part being placed on the downstream side of the discharge mechanism in the conveyance direction.

19. A pressure-sensitive adhesive strength exhibiting unit according to claim 18,
wherein the control part is configured to switch between a pressure-sensitive adhesive strength exhibiting mode for exhibiting pressure-sensitive adhesive strength and a position adjustment mode for adjusting the position of the discharge roller, and that the control part be configured to apply, when entering the position adjustment mode, heat energy to the plurality of heat generating elements so that the pressure-sensitive adhesive strength non-exhibiting region is formed in a state in which a lateral width of the pressure-sensitive adhesive strength non-exhibiting region is reduced in a stepwise manner from the downstream end of the pressure-sensitive adhesive label.

20. A pressure-sensitive adhesive strength exhibiting unit according to claim 19,
wherein the control part is configured to apply heat energy to the plurality of heat generating elements so that the lateral width of the pressure-sensitive adhesive strength non-exhibiting region is changed in a stepwise manner in association with a length from the downstream end of the pressure-sensitive adhesive label along the conveyance direction, and to calculate, when the detection part detects the sagging, the lateral width of the pressure-sensitive adhesive strength non-exhibiting region at a time of the detection based on a length of the pressure-sensitive adhesive label from the downstream end of the pressure-sensitive adhesive label to a detected position.
